(19) United States
(12) Patent Application Publication
(10) Pub. No.: US 2026/0101139 A1
(43) Pub. Date: Apr. 9, 2026

(54) ACOUSTIC DEVICES

(71) Applicant: SHENZHEN SHOKZ CO., LTD., Shenzhen (CN)

(72) Inventors: Jianing LIANG, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/415,749

(22) Filed: Dec. 10, 2025

Related U.S. Application Data
(63) Continuation of application No. PCT/CN2024/114043, filed on Aug. 22, 2024.

(51) Int. Cl. H04R 1/34; H04R 1/10; H04R 7/04; H04R 7/18

(52) U.S. Cl. CPC H04R 1/345; H04R 1/1008; H04R 1/1075; H04R 7/04; H04R 7/18; H04R 1/105; H04R 2460/11

(57) ABSTRACT

The present disclosure relates to an acoustic device, including a sound output unit and a suspension structure. In a wearing state, a sound outlet hole is provided on an inner side surface of a housing of the sound output unit, and one or more pressure relief holes are provided on other side surfaces. On a reference plane parallel or tangent to a side surface where an effective vent port of each of the one or more pressure relief hole is located, the effective vent port o has a first projection, and the sound outlet hole has a second projection. The first projection defines a plurality of first feature line segments that are perpendicular to the inner side surface, two endpoints of each of the plurality of first feature line segments are located on a contour of the first projection, and the plurality of first feature line segments are parallel to each other. For each of the plurality of first feature line segments, an endpoint of the two endpoints that is farther from the second projection is defined as a reference point. The plurality of reference points of the plurality of first feature line segments include a first reference point and a second reference point, a distance from the first reference point to the second projection is less than a distance from the second reference point to the second projection, the plurality of first feature line segments include a first sub-line segment and a second sub-line segment, the first sub-line segment passes through the first reference point, the second sub-line segment passes through the second reference point, the first sub-line segment has a first length, the second sub-line segment has a second length, and the first length is less than the second length.

### CROSS-REFERENCE TO RELATED APPLICATION

This application is a continuation of International Application No. PCT/CN2024/114043, filed on Aug. 22, 2024, the contents of which are incorporated herein by reference

### TECHNICAL FIELD

The present disclosure relates to the field of acoustic technology, and in particular, to an acoustic device.

### BACKGROUND

With the development of acoustic output technology, acoustic devices have been widely used in people's daily lives. The acoustic devices may be used in conjunction with electronic devices such as a mobile phone, a computer, or the like, so as to provide users with an auditory feast. In an acoustic device, a sound outlet hole is generally provided to output a sound generated at a front side of a diaphragm, and a pressure relief hole is provided to output a sound generated at a rear side of the diaphragm. The design of the pressure relief hole has a significant impact on the output performance of the acoustic device.

Therefore, it is necessary to propose an acoustic device to improve the output effect of the acoustic device by designing the pressure relief hole.

### SUMMARY

Embodiments of the present disclosure provide an acoustic device, including: a sound output unit and a suspension structure. The sound output unit includes a housing and a diaphragm accommodated in the housing. The diaphragm is configured to generate a sound through vibration. The suspension structure is configured to position the sound output unit near an ear canal of a user without blocking the ear canal. In a wearing state, an inner side surface of the housing facing an auricle of the user is provided with a sound outlet hole. The sound outlet hole is configured to guide a sound generated at a front side of the diaphragm out of the housing. Side surfaces of the housing other than the inner side surface are provided with one or more pressure relief holes. The one or more pressure relief holes are configured to guide a sound generated at a rear side of the diaphragm out of the housing. Each of the one or more pressure relief holes includes an effective vent port. The effective vent port has a first projection on a reference plane. The reference plane is parallel or tangent to a side surface where the effective vent port is located. The reference plane is perpendicular to the inner side surface. The first projection defines a plurality of first feature line segments that are perpendicular to the inner side surface. Two endpoints of each of the plurality of first feature line segments are located on a contour of the first projection, and the plurality of first feature line segments are parallel to each other. The sound outlet hole has a second projection on the reference plane. For each of the first feature line segments, an endpoint of the two endpoints that is farther from the second projection is defined as a reference point. The plurality of reference points of the plurality of first feature line segments include a first reference point and a second reference point. A distance from the first reference point to the second projection is less than a distance from the second reference point to the second projection. The plurality of first feature line segments include a first sub-line segment and a second sub-line segment. The first sub-line segment passes through the first reference point. The second sub-line segment passes through the second reference point. The first sub-line segment has a first length, the second sub-line segment has a second length, and the first length is less than the second length.

Embodiments of the present disclosure further provide an acoustic device, including: a sound output unit and a suspension structure. The sound output unit includes a housing and a diaphragm accommodated in the housing. The diaphragm is configured to generate a sound through vibration. The suspension structure is configured to position the sound output unit near an ear canal of a user without blocking the ear canal. In a wearing state, an inner side surface of the housing facing an auricle of the user is provided with a sound outlet hole. The sound outlet hole is configured to guide a sound generated at a front side of the diaphragm out of the housing. Side surfaces of the housing other than the inner side surface are provided with one or more pressure relief holes. The one or more pressure relief holes are configured to guide a sound generated at a rear side of the diaphragm out of the housing. Each of the one or more pressure relief holes includes an effective vent port. The effective vent port has a first projection on a reference plane. The reference plane is parallel or tangent to a side surface where the effective vent port is located. The first projection defines a plurality of second feature line segments that are perpendicular to the inner side surface. Two endpoints of each of the plurality of second feature line segments are located on a contour of the first projection, and the plurality of second feature line segments are parallel to each other. The sound outlet hole has a second projection on the reference plane. For each of the plurality of second feature line segments, an endpoint of the two endpoints that is closer to a center of the second projection is defined as a reference point. The plurality of reference points of the plurality of first feature line segments include a third reference point and a fourth reference point. A distance from the third reference point to the center of the second projection is less than a distance from the fourth reference point to the center of the second projection. The plurality of second feature line segments include a third sub-line segment and a fourth sub-line segment. The third sub-line segment passes through the third reference point. The fourth sub-line segment passes through the fourth reference point. The third sub-line segment has a third length, the fourth sub-line segment has a fourth length, and the third length is less than the fourth length.

### BRIEF DESCRIPTION OF THE DRAWINGS

The present disclosure will be further described by way of exemplary embodiments, and the exemplary embodiments will be described in detail with reference to the accompanying drawings. The embodiments are non-limiting, and in the embodiments, the same reference numerals denote the same structures.

FIG. 1 is a schematic diagram illustrating an exemplary ear portion according to some embodiments of the present disclosure.

FIG. 2A is a schematic diagram illustrating an exemplary structure of an acoustic device according to some embodiments of the present disclosure.

FIG. 2B is a schematic diagram illustrating another exemplary structure of the acoustic device shown in FIG. 2A.

FIG. 3 is a schematic diagram illustrating an exemplary internal structure of a sound output unit according to some embodiments of the present disclosure.

FIGS. 4A and 4B are schematic diagrams illustrating different inner side surfaces according to some embodiments of the present disclosure.

FIG. 5 is a schematic diagram illustrating an exemplary structure of a pressure relief hole according to some embodiments of the present disclosure.

FIGS. 6A and 6B are schematic diagrams illustrating a projection of a sound output unit on a first reference plane according to some embodiments of the present disclosure.

FIG. 7 is a schematic diagram illustrating frequency response curves of an acoustic device corresponding to a pressure relief hole when an angle between a second side edge and a first side edge is different according to some embodiments of the present disclosure.

FIG. 8A is a schematic diagram illustrating positions of a first reference point and a second reference point according to some embodiments of the present disclosure.

FIG. 8B is a schematic diagram illustrating positions of a third reference point and a fourth reference point according to some embodiments of the present disclosure.

FIG. 9 is a schematic diagram illustrating of an exemplary structure of a second pressure relief hole according to some embodiments of the present disclosure.

FIGS. 10A and 10B are schematic diagrams illustrating positions of different reference points according to some embodiments of the present disclosure.

### DETAILED DESCRIPTION

To more clearly illustrate the technical solutions of the embodiments of the present disclosure, the accompanying drawings required for describing the embodiments will be briefly introduced below. Obviously, the accompanying drawings in the following description are merely some examples or embodiments of the present disclosure. For ordinary skilled in the art, the present disclosure may also be applied to other similar scenarios based on these accompanying drawings without exerting creative labor. Unless it is obvious from the context or otherwise stated, the same reference numerals in the drawings denote the same structures or operations.

In an acoustic device, a sound outlet hole is generally designed to output a sound generated at a front side of a diaphragm, and a pressure relief hole is designed to output a sound generated at a rear side of the diaphragm. Through the design of the sound outlet hole and the pressure relief hole, the sounds output by the two can achieve inverse phase cancellation in the far field, which helps reduce sound leakage of the acoustic device in the far field. Meanwhile, to avoid an acoustic short-circuit caused by the cancellation of sounds output by the sound outlet hole and the pressure relief hole in the near field, which may affect the user's listening effect, the pressure relief hole needs to be disposed as far away from the sound outlet hole as possible. On the other hand, to reduce the impact caused by standing waves, the pressure relief hole needs to have a relatively large opening area to ensure sufficient air permeability. To solve the above problems, the present disclosure designs the shape of the pressure relief hole, so that the portion of the pressure relief hole close to the sound outlet hole is narrow, and the portion far away from the sound outlet hole is wide, thereby ensuring that the one or more pressure relief holes has sufficient air permeability while avoiding the acoustic short-circuit.

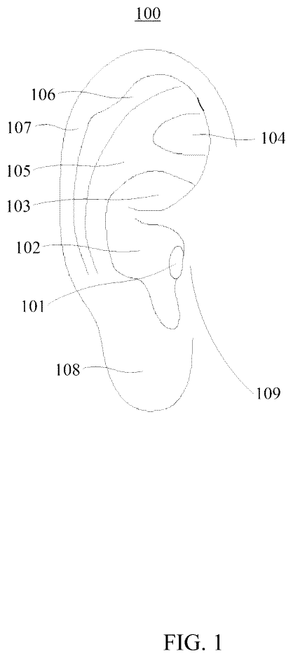

FIG. 1 is a schematic diagram illustrating an exemplary ear portion according to some embodiments of the present disclosure. Referring to FIG. 1, an ear portion 100 may include an ear canal 101, a concha cavum 102, a concha cymba 103, a triangular fossa 104, an antihelix 105, a scaphoid fossa 106, a helix 107, an earlobe 108, and a helix crus 109. In some embodiments, wearing and stabilization of the acoustic device may be achieved by means of one or more parts of the ear portion 100. In some embodiments, parts such as the ear canal 101, the concha cavum 102, the concha cymba 103, and the triangular fossa 104 have a certain depth and volume in a three-dimensional space, which may be used to meet the wearing requirements of the acoustic device. Merely by way of example, the acoustic device (e.g., in-ear headphones) may be worn in the ear canal 101. In some embodiments, wearing of the acoustic device may be achieved by means of parts of the ear portion 100 other than the ear canal 101. For example, wearing of the acoustic device may be achieved by means of parts such as the concha cymba 103, the triangular fossa 104, the antihelix 105, the scaphoid fossa 106, the helix 107, or a combination thereof. In some embodiments, to improve comfort and reliability of the acoustic device in terms of wearing, parts such as the user's earlobe 108 may be further used. By means of parts of the ear portion 100 other than the ear canal 101 to achieve wearing of the acoustic device and sound transmission, the user's ear canal 101 can be “liberated”, and the impact of the acoustic device on the user's ear health can be reduced. When the user wears the acoustic device on the road, the acoustic device will not block the user's ear canal 101, and the user can receive both sounds from the acoustic device and sounds from the environment (e.g., horn sounds, bicycle bell sounds, surrounding human voices, traffic command sounds, or the like), thereby reducing the probability of traffic accidents. For example, when the user wears the acoustic device, the entire or part of the structure of the acoustic device may be located at the front side of the helix crus 109. As another example, when the user wears the acoustic device, the entire or part of the structure of the acoustic device may be in contact with the upper part of the ear canal 101 (e.g., the position where one or more parts such as the helix crus 109, the concha cymba 103, the triangular fossa 104, the antihelix 105, the scaphoid fossa 106, the helix 107 are located). For yet another example, when the user wears the acoustic device, the entire or part of the structure of the acoustic device may be located in one or more parts of the ear portion (e.g., the concha cavum 102, the concha cymba 103, the triangular fossa 104, or the like).

In some embodiments, different users may have individual differences, resulting in dimensional differences such as different shapes and sizes of the ear portion. For the convenience of description and reducing individual differences among different users, a simulator including a head and its (left and right) ear portions may be manufactured based on ANSI: S3.36, S3.25 and IEC: 60318-7 standards, such as GRAS 45BC KEMAR. Therefore, in the present disclosure, descriptions such as “user wearing”, “in a wearing state” and “in the wearing state” may refer to the acoustic device described in the present disclosure being worn on the ear portion of the aforementioned simulator. Of course, precisely because different users have individual differences, the structure, shape, size, thickness, or the like of one or more parts of the ear portion 100 may be different, and there may be certain differences when the acoustic device is worn by different users compared with the acoustic device being worn on the ear portion of the aforementioned simulator, but such differences should be tolerable.

It should be noted that in fields such as medicine and anatomy, three basic planes including a sagittal plane, a coronal plane, and a horizontal plane, and three basic axes including a sagittal axis, a coronal axis, and a vertical axis of the human body may be defined. The sagittal plane refers to a plane perpendicular to the ground made along the anterior-posterior direction of the body, which divides the human body into left and right parts. The coronal plane refers to a plane perpendicular to the ground made along the left-right direction of the body, which divides the human body into anterior and posterior parts. The horizontal plane refers to a plane parallel to the ground made along the superior-inferior direction of the body, which divides the human body into superior and inferior parts. Correspondingly, the sagittal axis refers to an axis along the anterior-posterior direction of the body and perpendicular to the coronal plane. The coronal axis refers to an axis along the left-right direction of the body and perpendicular to the sagittal plane. The vertical axis refers to an axis along the superior-inferior direction of the body and perpendicular to the horizontal plane. Further, the “front side of the ear portion” described in the present disclosure is a concept relative to the “rear side of the ear portion”, the former refers to the side of the ear portion away from the head, and the latter refers to the side of the ear portion facing the head, both of which are directed to the user's ear portion. By observing the ear portion of the aforementioned simulator along the direction of the human coronal axis, a schematic diagram of the anterior contour of the ear portion as shown in FIG. 1 can be obtained.

The description of the aforementioned ear portion 100 is for illustrative purposes only and is not intended to limit the scope of the present disclosure. For ordinary skilled in the art, various changes and modifications may be made according to the description of the present disclosure. For example, part of the structure of the acoustic device may shield part or all of the ear canal 101. Such changes and modifications still fall within the protection scope of the present disclosure.

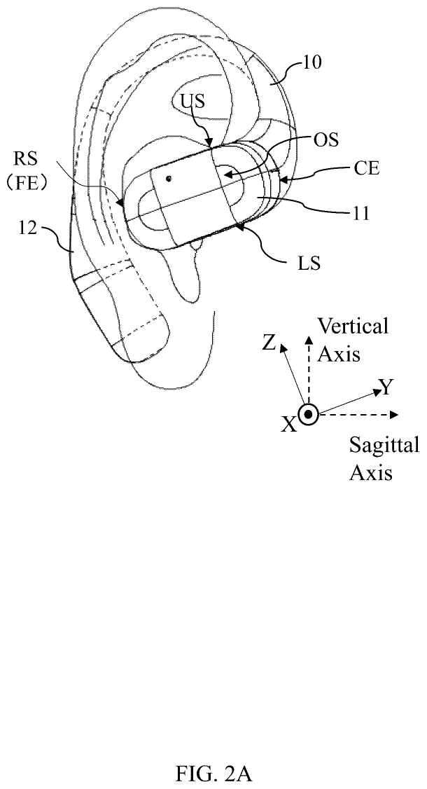

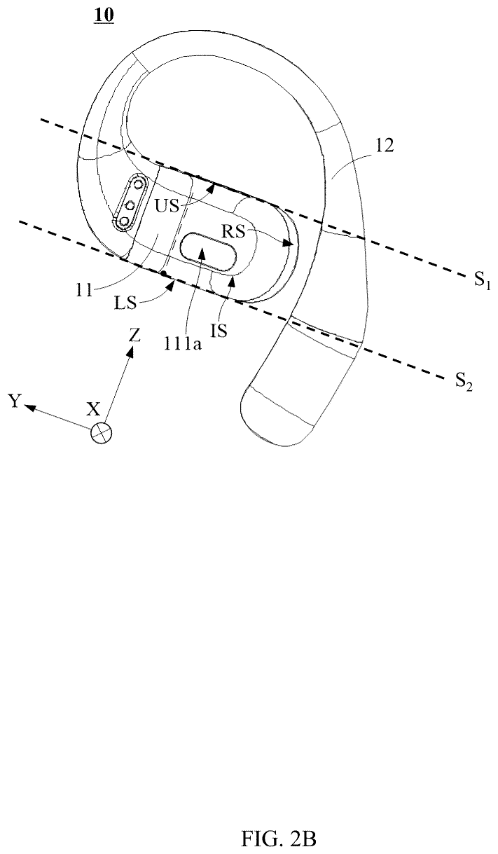

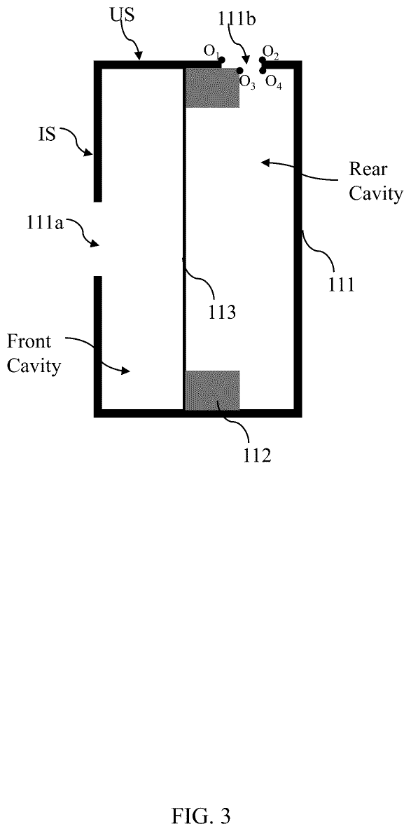

FIG. 2A is a schematic diagram illustrating an exemplary structure of an acoustic device according to some embodiments of the present disclosure. FIG. 2B is a schematic diagram illustrating another exemplary structure of the acoustic device shown in FIG. 2A. FIG. 3 is a schematic diagram illustrating an exemplary internal structure of a sound output unit according to some embodiments of the present disclosure. As shown in FIGS. 2A and 2B, an acoustic device 10 may include a sound output unit 11 and a suspension structure 12. In some embodiments, the acoustic device 10 may position the sound output unit 11 on the user's body (e.g., the user's head, neck, or upper portion torso) through the suspension structure 12.

In some embodiments, the suspension structure 12 may be an arc-shaped structure adapted to the auricle of the user, so that the suspension structure 12 may be suspended at the user's upper auricle. In some embodiments, the suspension structure 12 may also be a clamping structure adapted to the auricle of the user, so that the suspension structure 12 may be clamped at the auricle of the user. In some embodiments, an end of the suspension structure 12 away from the auricle may be connected to the sound output unit 11, and the other end may extend along the auricle of the user. In some embodiments, the suspension structure 12 may include but is not limited to an ear hook, an elastic band, or the like, so that the acoustic device 10 may be better fixed on the user's body to prevent falling during use.

As shown in FIGS. 2A-3, in some embodiments, the sound output unit 11 may be configured to be worn on the user's body. The sound output unit 11 may include a housing 111 and a diaphragm 113 accommodated in the housing 111, and the diaphragm 113 is configured to generate a sound through vibration and input the sound into the user's ear portion 100. In some embodiments, the acoustic device 10 may be combined with products such as glasses, head-mounted headphones, head-mounted display devices, AR/VR helmets, or the like. In such cases, the sound output unit 11 may be fixed near the user's ear portion 100 in a suspended or clamped manner. In some embodiments, the shape of the housing 111 may be adapted to the human ear portion 100. For example, the shape of the housing 111 may be circular, elliptical, polygonal (regular or irregular), U-shaped, V-shaped, semicircular, or the like, so that the sound output unit 11 may be directly attached to the user's ear portion 100. In some embodiments, the sound output unit 11 may have a long axis direction Y and a short axis direction (i.e., a height or width direction) Z that are perpendicular to a thickness direction X and orthogonal to each other. The long axis direction Y may be defined as a direction in which the sound output unit 11 approaches or moves away from the back of the user's head in a wearing state, and the short axis direction Z may be defined as a direction in which the sound output unit 11 approaches or moves away from the top of the user's head in the wearing state. The thickness direction X may be consistent with the direction of the coronal axis, both pointing to the left and right directions of the body; alternatively, the thickness direction X may be defined as a direction in which the sound output unit 11 approaches or moves away from the user's head in the wearing state. In some embodiments, when the sound output unit 11 is horizontal in the wearing state, the long axis direction Y may be consistent with the direction of the sagittal axis, both pointing to the anterior-posterior direction of the body, and the short axis direction Z may be consistent with the direction of the vertical axis, both pointing to the superior-inferior direction of the body. In other embodiments, when the sound output unit 11 is inclined in the wearing state, the long axis direction Y and the short axis direction Z are still parallel to the sagittal plane. The long axis direction Y may form a certain angle with the direction of the sagittal axis, that is, the long axis direction Y is also arranged obliquely accordingly. The short axis direction Z may form a certain angle with the direction of the vertical axis, that is, the short axis direction Z is also arranged obliquely.

In some embodiments, when the user wears the acoustic device 10, the sound output unit 11 may be located above, below, on the front side (e.g., the front side of the tragus) of the user's ear portion 100, or inside the auricle (e.g., in the concha cavum). The housing 111 of the sound output unit 11 may also be provided with two or more acoustic holes for transmitting sound. In some embodiments, a speaker inside the sound output unit 11 may output sounds with a phase difference (e.g., opposite phases) through the two acoustic holes.

In some embodiments, the acoustic device 10 may include but is not limited to air conduction headphones, bone conduction headphones, or the like. In some embodiments, the acoustic device 10 may be an open-back headphone, and may not block the user's ear canal 101 when the acoustic device 10 is in the wearing state. In some embodiments, a projection of the acoustic device 10 on the user's ear plane may partially or completely cover but not block the user's ear canal 101. In other embodiments, the projection of the acoustic device 10 on the user's ear plane may not cover the user's ear canal 101.

In some embodiments, the sound output unit 11 may have a connection end CE connected to the suspension structure 12 and a free end FE not connected to the suspension structure 12, and the free end FE is disposed away from the connection end CE. In some embodiments, the sound output unit 11 may have an inner side surface IS facing the ear portion and an outer side surface OS away from the ear portion, which are arranged along the thickness direction X in the wearing state. The sound output unit 11 may also have a connecting surface connecting the inner side surface IS and the outer side surface OS. Further, at least part of the aforementioned connecting surface is located in the concha cavum in the wearing state, and forms a first contact region with the front side of the aforementioned ear portion region (e.g., the ear portion region corresponding to the concha cavum, the antihelix, or the like). The suspension structure 12 forms a second contact region with the rear side of the ear portion region in the wearing state, and the second contact region and the first contact region at least partially overlap in the ear thickness direction of the ear portion region. In this way, not only the sound output unit 11 and the suspension structure 12 can jointly clamp the ear portion from the front and rear sides of the ear portion, but also the formed clamping force is mainly manifested as compressive stress, which helps improve the stability and comfort of the acoustic device 10 in the wearing state. In the wearing state, when observed along the direction of the coronal axis (i.e., the thickness direction X), the sound output unit 11 (housing 111) may be configured in shapes such as circular, elliptical, square with rounded corners, rectangular with rounded corners, or the like. When the sound output unit 11 is configured in a shape such as circular or elliptical, the connecting surface may refer to an arc-shaped side surface of the housing 111 of the sound output unit 11; when the sound output unit 11 is configured in a shape such as square with rounded corners or rectangular with rounded corners, the connecting surface may include a lower side surface LS, an upper side surface US, and a rear side surface RS mentioned below. In some embodiments, the connecting surface may also include edges connecting the respective side surfaces, for example, an arc-shaped edge connecting the upper side surface US and the inner side surface IS. Therefore, for the convenience of description, this embodiment takes the sound output unit 11 configured as a rectangular with rounded corners as an example for exemplary description. In some embodiments, the sound output unit 11 may have an upper side surface US and a lower side surface LS arranged along the short axis direction Z, and a rear side surface RS connecting the upper side surface US and the lower side surface LS. The upper side surface US is located at an end facing the top of the head along the short axis direction Z in the wearing state, the rear side surface RS is located at an end facing the back of the head along the long axis direction Y in the wearing state, and at least part of the free end FE is located on the rear side surface RS. In some embodiments, as shown in FIG. 2A, the positive direction of the long axis direction Y may point to the connection end CE, the positive direction of the short axis direction Z may point to the upper side surface US, and the positive direction of the thickness direction X may point to the outer side surface OS.

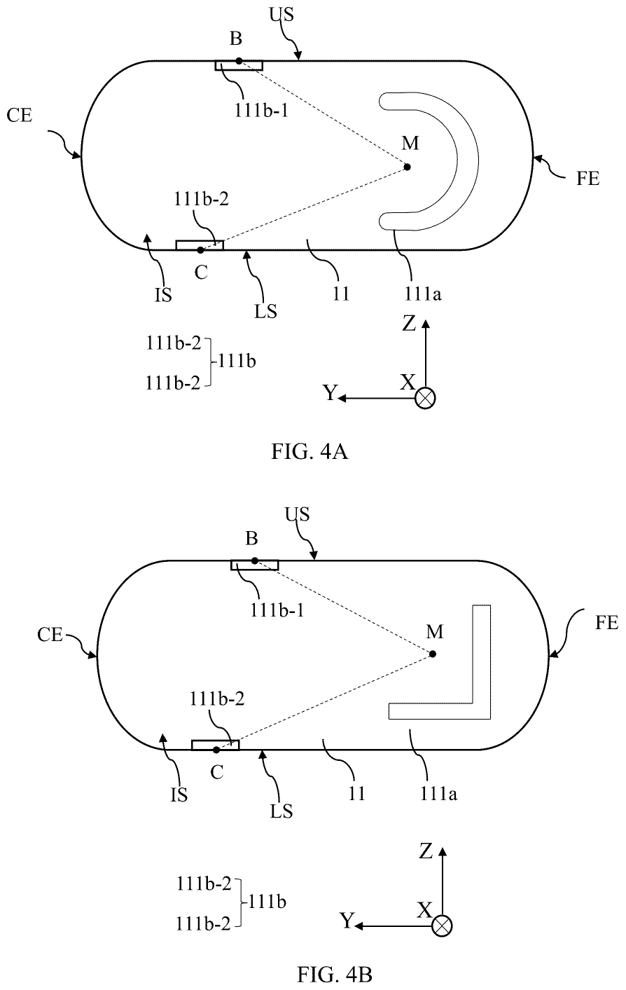

FIGS. 4A and 4B are schematic diagrams illustrating different inner side surfaces according to some embodiments of the present disclosure. As shown in FIG. 2B, FIG. 4A, and FIG. 4B, in some embodiments, the inner side surface IS of the housing 111 facing the ear portion in the wearing state is provided with a sound outlet hole 111a, and the sound outlet hole 111a is configured to guide a sound generated at a front side of the diaphragm 113 out of the housing 111, so as to be transmitted into the user's ear canal 101. In some embodiments, the sound outlet hole 111a may be in a circular shape, a racetrack shape (as shown in FIG. 2B), a U-shape (as shown in FIG. 4A), an L-shape (as shown in FIG. 4B), or the like. By designing the shape of the sound outlet hole 111a, the space of the inner side surface IS may be rationally utilized to make the sound outlet hole 111a closer to the ear canal in the wearing state, and the resonant frequency of a front cavity at the front side of the diaphragm 113 communicated with the sound outlet hole 111a may be adjusted, thereby improving the output performance of the acoustic device 10.

In some embodiments, side surfaces of the housing 111 other than the inner side surface IS (e.g., the lower side surface LS, the upper side surface US, the outer side surface OS, the rear side surface RS, or the like) are provided with one or more pressure relief holes (e.g., at least one of a first pressure relief hole and a second pressure relief hole), and the one or more pressure relief holes are configured to guide a sound generated at a rear side of the diaphragm 113 out of the housing 111.

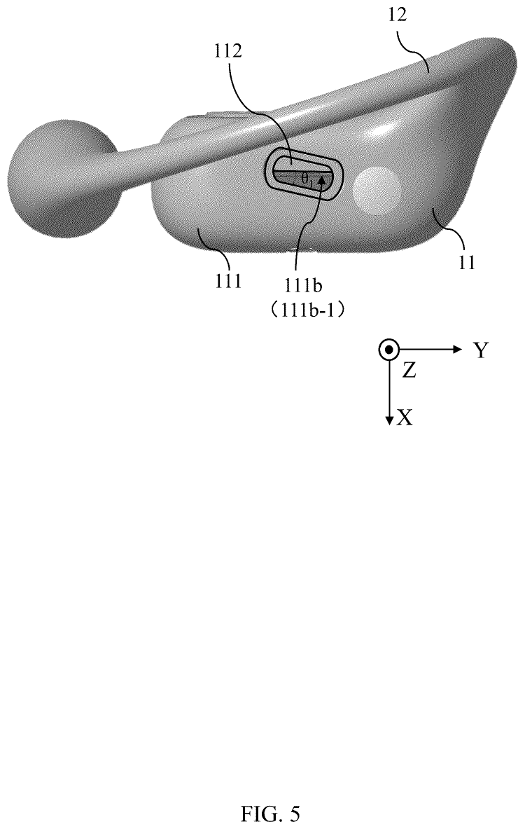

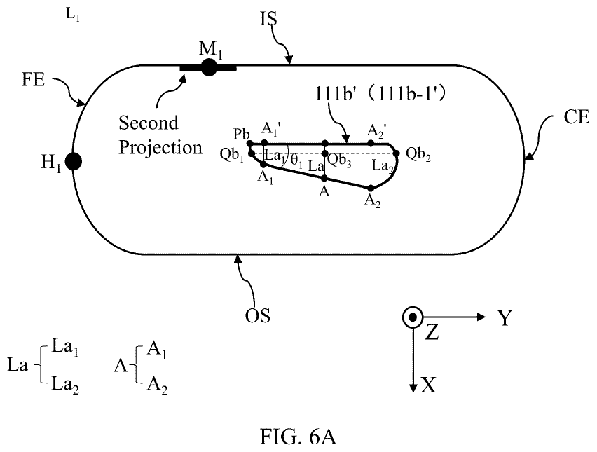

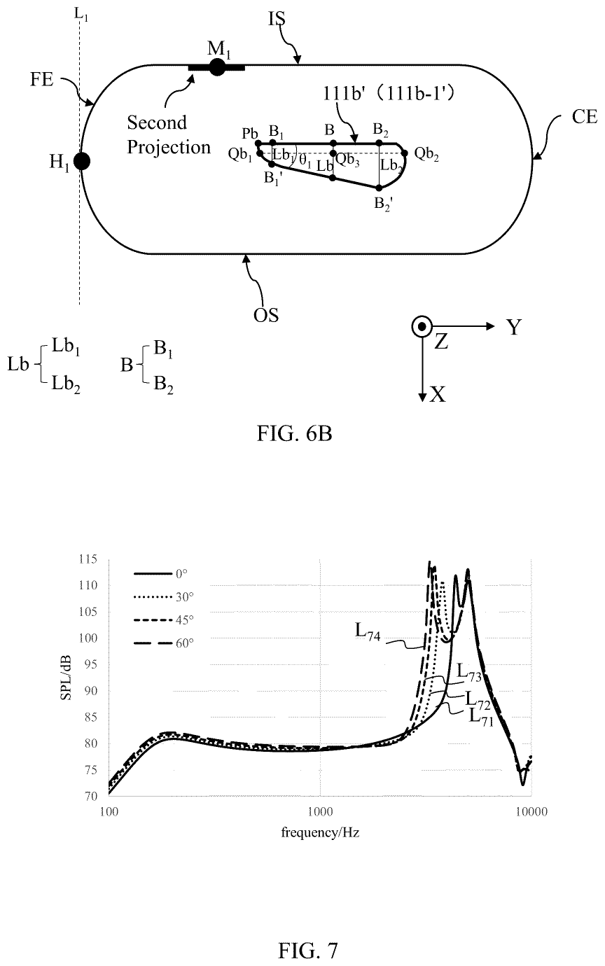

FIG. 5 is a schematic diagram illustrating an exemplary structure of a pressure relief hole according to some embodiments of the present disclosure. FIGS. 6A and 6B are schematic diagrams illustrating a projection of a sound output unit on a first reference plane according to some embodiments of the present disclosure.

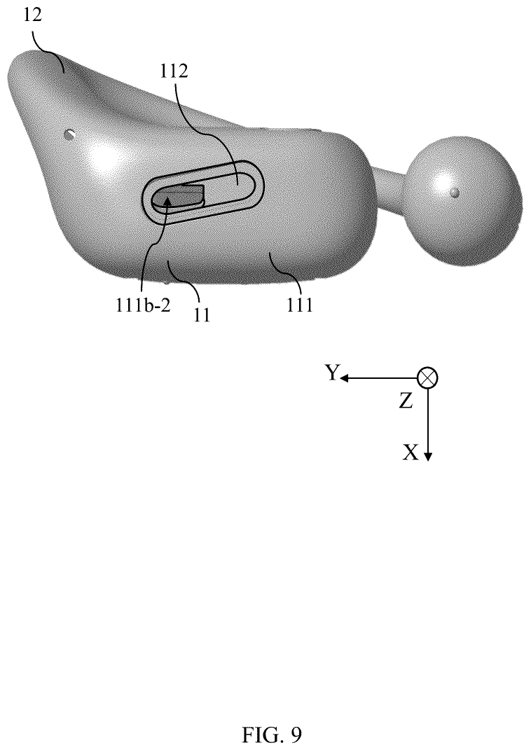

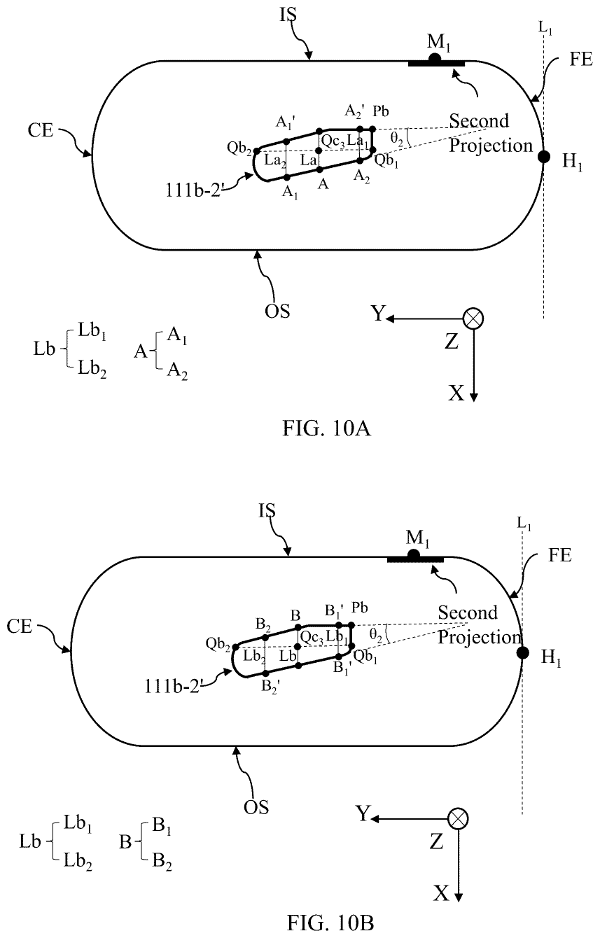

In some embodiments, a pressure relief hole 111b may include an effective vent port. In some embodiments, the diaphragm 113 may be connected to the housing 111 via a bracket 112, and the pressure relief hole 111b (e.g., a first pressure relief hole 111b-1, a second pressure relief hole 111b-2, or the like) includes an outer port formed on the housing 111 and an inner port defined by the bracket 112 and the housing 111, as shown in FIG. 3 and FIG. 5. An area enclosed by the inner port is less than an area enclosed by the outer port, and the inner port constitutes the effective vent port. In some embodiments, referring to FIG. 3, the outer port may refer to a port of the pressure relief hole 111b disposed on an outer side of the housing 111, i.e., the port where point O₁ and point O₂ are located; the inner port may refer to a port of the pressure relief hole 111b enclosed by an inner side of the housing 111 and the bracket 112, i.e., the port where point O₃ and point O₄ are located. In some embodiments, referring to FIG. 5 and FIG. 9, the outer port refers to a racetrack-shaped port of the pressure relief hole 111b formed on the housing 111 (e.g., an outer racetrack-shaped or inner racetrack-shaped port shown in FIG. 5 and FIG. 9); the inner port refers to a port of the pressure relief hole 111b enclosed by the housing 111 and the bracket 112, for example, a port enclosed by an inner racetrack shape and the bracket 112 in FIG. 5, which has a shape corresponding to a projection 111b-1′shown in FIG. 6A and FIG. 6B, or a port enclosed by an inner racetrack shape and the bracket 112 in FIG. 9, which has a shape corresponding to a projection 111b-2′shown in FIG. 10A and FIG. 10B.

In some embodiments, a distance between the pressure relief hole 111b and the sound outlet hole 111a may be in a range of 12 mm to 20 mm, so as to maintain a relatively large distance between the pressure relief hole 111b and the sound outlet hole 111a, avoid the acoustic short-circuit, and prevent the sound output unit 11 from being excessively large due to an excessively large distance between the pressure relief hole 111b and the sound outlet hole 111a, thereby improving wearing comfort of the acoustic device 10. In some embodiments, to further avoid acoustic the short-circuit and avoid the sound output unit 11 from being excessively large, the distance between the pressure relief hole 111b and the sound outlet hole 111a may be in a range of 13 mm to 17 mm. The distance between the pressure relief hole 111b and the sound outlet hole 111a may refer to a distance between a center (e.g., a centroid) of the pressure relief hole 111b and a center point M (e.g., a centroid) of the sound outlet hole 111a. In some embodiments, the center point M of the sound outlet hole 111a may be a centroid of an outer end surface of the sound outlet hole 111a. In some embodiments, the center point M of the sound outlet hole 111a may also be a selected point that meets design requirements. For example, when the shape of the sound outlet hole 111a is a semicircular ring, the center point M may be a point where an inner ring of the semicircular ring intersects with an axis of symmetry. As another example, when the sound outlet hole 111a is in an L-shape, the center point M may be a corner point. In some embodiments, the center point M of the sound outlet hole 111a may be an equivalent centroid of the outer end surface of the sound outlet hole 111a, as shown in FIG. 4A or FIG. 4B.

In some embodiments, the pressure relief hole 111b includes an effective vent port, and the effective vent port has a first projection 111b′ on a reference plane S. The reference plane S may be parallel or tangent to a side surface where the effective vent port is located. Exemplarily, the pressure relief hole 111b may be disposed on the upper side surface US of the sound output unit 11, and the effective vent port of the pressure relief hole 111b has the first projection 111b′ on the reference plane S. When the upper side surface US is a plane, the reference plane S may be parallel to the upper side surface US, or a plane where the upper side surface US is located is the reference plane S. When the upper side surface US is a curved surface, the reference plane S may be tangent to the upper side surface US.

In some embodiments, the reference plane S may be perpendicular to or intersect obliquely with the inner side surface IS of the sound output unit 11.

In some embodiments, the sound outlet hole 111a has a second projection on the reference plane S. In some embodiments, the reference plane S may be perpendicular to the inner side surface IS. Exemplarily, when the pressure relief hole 111b is disposed on the upper side surface US and not located at an edge of the upper side surface US, the second projection corresponding to the sound outlet hole 111a is a line segment, as shown in FIG. 6A and FIG. 6B. In some embodiments, the reference plane S may not be perpendicular to the inner side surface IS (e.g., when the pressure relief hole 111b is disposed at an edge where the upper side surface US intersects with the inner side surface IS), and at this time, the second projection corresponding to the sound outlet hole 111a is a closed geometric figure. For the convenience of description, a projection point M₁ of the center point M of the sound outlet hole 111a on the reference plane S may be used to indicate a position of the second projection; alternatively, a centroid or center (e.g., the point M₁) of the second projection may be used to indicate the position of the second projection.

Referring to FIG. 6A, in some embodiments, when the reference plane S is perpendicular to the inner side surface IS, the second projection corresponding to the sound outlet hole 111a may be a line segment. The first projection 111b′ may define a plurality of first feature line segments La that are perpendicular to the inner side surface IS, two endpoints of each of the plurality of first feature line segments La are located on a contour of the first projection 111b', and the plurality of first feature line segments La are parallel to each other. For each of the first feature line segments La, an endpoint of the two endpoints that is farther from the second projection may be defined as a reference point A, and the plurality of reference points A of the plurality of first feature line segments La include a first reference point A₁ and a second reference point A₂. A distance from the first reference point A₁ to the second projection is less than a distance from the second reference point A₂ to the second projection. It should be noted that since the second projection is a line segment (as shown in FIG. 6A), the distance from the reference point A (e.g., the first reference point A₁ and the second reference point A₂) to the second projection refers to a length of a perpendicular line segment drawn from the reference point A to the second projection. The plurality of first feature line segments La include a first sub-line segment La₁ passing through the first reference point A₁ and a second sub-line segment La₂ passing through the second reference point A₂. The first sub-line segment La₁ has a first length, the second sub-line segment La₂ has a second length, and the first length is less than the second length. That is, on the first projection 111b', the part farther from the second projection has a larger size, and the part closer to the second projection has a smaller size, so that the center of the first projection 111b′ is as far away from the second projection as possible while the first projection 111b′ has a relatively large area, thereby ensuring sufficient air permeability of the pressure relief hole 111b while avoiding the acoustic short-circuit.

Referring to FIG. 6B, in some embodiments, when the reference plane S is perpendicular to or inclined relative to the inner side surface IS, the projection point M₁ of the center point M of the sound outlet hole 111a on the reference plane S may be used to indicate the position of the second projection; alternatively, the centroid or center (e.g., the point M₁) of the second projection may be used to indicate the position of the second projection. At this time, the first projection 111b′ may define a plurality of second feature line segments Lb that are perpendicular to the inner side surface IS, two endpoints of each of the plurality of second feature line segments Lb are located on the contour of the first projection 111b', and the plurality of second feature line segments Lb are parallel to each other. For each of the plurality of second feature line segments Lb, an endpoint of the two endpoints that is closer to the center point M₁ of the second projection is defined as a reference point B, and the plurality of reference points B of the plurality of second feature line segments Lb include a third reference point B₁ and a fourth reference point B₂. A distance from the third reference point B₁ to the center point M₁ of the second projection is less than a distance from the fourth reference point B₂ to the center point M₁ of the second projection. The plurality of second feature line segments Lb include a third sub-line segment Lb₁ passing through the third reference point B₁ and a fourth sub-line segment Lb₂ passing through the fourth reference point B₂. The third sub-line segment Lb₁ has a third length, the fourth sub-line segment Lb₂ has a fourth length, and the third length is less than the fourth length. That is, on the first projection 111b', the part farther from the center point M₁ of the second projection has a larger size, and the part closer to the center point M₁ of the second projection has a smaller size, so that the center of the first projection 111b′ is as far away from the center point M₁ of the second projection as possible while the first projection 111b′ has a relatively large area, thereby ensuring the sufficient air permeability of the first pressure relief hole 111b while avoiding the acoustic short-circuit.

In some embodiments, on the acoustic device 10, the plurality of first feature line segments La (or the plurality of second feature line segments Lb) may be defined on the effective vent port of the pressure relief hole 111b. For the plurality of first feature line segments La (or the plurality of second feature line segments Lb), the closer the reference point A of a specific first feature line segment La (or the reference point B of a specific second feature line segment Lb) is to the centroid of the sound outlet hole 111a, the shorter the length of the specific first feature line segment La (or the specific second feature line segment Lb) corresponding to the reference point A (or the reference point B) is compared to other first feature line segments La in the plurality of first feature line segments La (or other second feature line segments Lb in the plurality of second feature line segments Lb). That is, the part of the pressure relief hole 111b close to the sound outlet hole 111a has a small size, and the part far away from the sound outlet hole 111a has a large size, thereby ensuring the sufficient air permeability of the pressure relief hole 111b while avoiding the acoustic short-circuit.

In some embodiments, the projection of the sound output unit 11 on the reference plane S has a long axis direction Y′, and the long axis direction Y′ of the projection may be the same as the long axis direction Y of the sound output unit 11, or an angle between the long axis direction Y′ of the projection and the long axis direction Y of the sound output unit may not exceed 10°.

In some embodiments, in the long axis direction Y′ of the projection of the sound output unit 11 on the reference plane S, the third reference point B₁ and the fourth reference point B₂ may be located on the same side of the center point M₁ of the second projection, that is, the first projection 111b′ is entirely located on the same side of the center point M₁ of the second projection in the long axis direction Y′, so that the center of the first projection 111b′ is as far away from the center point M₁ of the second projection as possible, thereby making the pressure relief hole 111b as far away from the sound outlet hole 111a as possible to avoid the acoustic short-circuit. Referring to FIG. 6B, exemplarily, the reference point B is all located on the side closer to the connection end CE relative to the center point M₁ of the second projection.

In some embodiments, on the acoustic device 10, in the long axis direction Y, the pressure relief hole 111b may be entirely located on the same side of the sound outlet hole 111a, so that the center of the pressure relief hole 111b is as far away from the sound outlet hole 111a as possible, thereby making the pressure relief hole 111b as far away from the sound outlet hole 111a as possible to avoid the acoustic short-circuit. In other embodiments, in the long axis direction Y, the sound outlet hole 111a may also at least partially overlap with the pressure relief hole 111b, so as to minimize the impact of opening acoustic holes on the overall size of the acoustic device while avoiding the acoustic short-circuit as much as possible.

In some embodiments, the first projection 111b′ includes a first side edge (not labeled in the figure) parallel to the long axis direction Y′ and a second side edge (not labeled in the figure) disposed opposite to the first side edge.

In some embodiments, since the first side edge of the first projection 111b′ is substantially parallel to the long axis direction Y′ of the projection of the sound output unit 11 on the reference plane S, a first side wall of the effective vent port of the pressure relief hole 111b corresponding to the first side edge is substantially parallel to the long axis direction Y of the sound output unit 11. Meanwhile, the effective vent port of the pressure relief hole 111b has a second side wall corresponding to the second side edge, and the relative relationship between the first side wall and the second side wall may be substantially the same as the relative relationship between the first side edge and the second side edge.

Referring to FIG. 6B, the first reference point A₁ and the second reference point A₂ may both be located on the second side edge. By arranging both the first reference point A₁ and the second reference point A₂ on the second side edge, it facilitates limiting the distance from the first reference point A₁ to the line segment shown by the second projection and the distance from the second reference point A₂ to the line segment shown by the second projection, thereby facilitating delineating the first sub-line segment La₁ and the second sub-line segment La₂. Further, the pressure relief hole 111b is designed into a relatively regular shape, reducing the processing difficulty of the pressure relief hole 111b.

Referring to FIG. 6B, in some embodiments, the third reference point B₁ and the fourth reference point B₂ may both be located on the first side edge. By arranging both the third reference point B₁ and the fourth reference point B₂ on the first side edge, it facilitates delineating the third sub-line segment Lb₁ and the fourth sub-line segment Lb₂ among the plurality of second feature line segments Lb. Further, the pressure relief hole 111b is designed into a relatively regular shape, reducing the processing difficulty of the pressure relief hole 111b.

On the other hand, referring to FIG. 5 and FIG. 6A, the first side wall of the effective vent port of the pressure relief hole 111b may be enclosed by the bracket 112. When the inclination angle of the pressure relief hole 111b relative to the long axis direction Y is different, the first side wall remains substantially parallel to the long axis direction Y, that is, the first side edge of the first projection 111b′ remains substantially parallel to the long axis direction Y′. The position of the reference point B on the first projection 111b′ corresponding to the pressure relief hole 111b with different inclination degrees remains unchanged, facilitating distinguishing the third sub-line segment Lb₁ and the fourth sub-line segment Lb₂.

Referring to FIG. 6A, in some embodiments, for the plurality of first feature line segments La, the longer the distance from the reference point A of a specific first feature line segment La to the second projection (i.e., the length of the perpendicular line segment drawn from the reference point A to the second projection), the longer the length of the specific first feature line segment La is compared to other first feature line segments La in the plurality of first feature line segments La. That is, the part of the first projection 111b′ farther from the second projection has a larger size, thereby making the centroid of the first projection 111b′ farther from the second projection, and further making the pressure relief hole 111b farther from the sound outlet hole 111a to avoid the acoustic short-circuit.

Referring to FIG. 6B, in some embodiments, in the long axis direction Y′, for the plurality of second feature line segments Lb, the longer the distance from the reference point B of a specific second feature line segment Lb to the center of the second projection (i.e., the point M₁), the longer the length of the specific second feature line segment Lb is compared to other second feature line segments Lb in the plurality of second feature line segments Lb. That is, the part of the first projection 111b′ farther from the center point M₁ of the second projection has a larger size, thereby making the centroid of the first projection 111b′ farther from the center point M₁ of the second projection, and further making the pressure relief hole 111b farther from the sound outlet hole 111a to avoid the acoustic short-circuit.

In some embodiments, the length of the first feature line segment La or the second feature line segment Lb is in a range of 0.5 mm to 1.6 mm, so that the first projection 111b′ has a relatively large area, that is, the effective vent port of the pressure relief hole 111b has a relatively large area, ensuring sufficient air permeability of the pressure relief hole 111b. In some embodiments, on the acoustic device 10, the dimension of the pressure relief hole 111b in the thickness direction X of the sound output unit 11 is in a range of 0.5 mm to 1.6 mm.

In some embodiments, the plurality of first feature line segments La or the plurality of second feature line segments Lb have a minimum length. The minimum length of the plurality of first feature line segments La may refer to a length of a specific first feature line segment La corresponding to a reference point A closest to the second projection on the second side edge of the first projection 111b′, such as the leftmost first sub-line segment La₁ shown in FIG. 6A. The minimum length of the plurality of second feature line segments Lb may refer to a length of a specific second feature line segment Lb corresponding to a reference point B closest to the center point M₁ of the second projection on the first side edge of the first projection 111b′, such as the leftmost third sub-line segment Lb₁ shown in FIG. 6B. If the minimum length of the plurality of first feature line segments La or the plurality of second feature line segments Lb is too small, it will cause the end of the first pressure relief hole 111b close to the sound outlet hole 111a to form a relatively sharp corner, thereby leading to reflection of sound with a short wavelength and introduction of noise, affecting the listening effect. In some embodiments, to minimize noise mixing in the output of the acoustic device 10, the minimum length of the plurality of first feature line segments La or the plurality of second feature line segments Lb may be not less than 0.5 mm, for example, in a range of 0.5 mm to 1 mm.

In some embodiments, the part of the effective vent port of the pressure relief hole 111b close to the sound outlet hole 111a may be a circular arc segment, that is, the ends of the first side wall and the second side wall close to the sound outlet hole 111a may be connected by the circular arc segment, so as to minimize the impact of sound wave reflection on listening. Exemplarily, as shown in FIG. 6A, at this time, the first side edge and the second side edge of the first projection 111b′ may be connected by the projection of the circular arc segment on the reference plane S, and one endpoint of the first feature line segment La or the second feature line segment Lb with the minimum length may be the connection point between the projection of the circular arc segment and the second side edge.

In some embodiments, a maximum length of the plurality of first feature line segments La may refer to a length of a specific first feature line segment La corresponding to a reference point A farthest from the second projection on the second side edge of the first projection 111b′, such as the rightmost second sub-line segment La₂ shown in FIG. 6A. In some embodiments, a maximum length of the plurality of second feature line segments Lb may refer to a length of a specific second feature line segment Lb corresponding to a reference point B farthest from the center point M₁ of the second projection on the first side edge of the first projection 111b′, such as the rightmost second sub-line segment Lb₂ shown in FIG. 6B. If the maximum length of the plurality of first feature line segments La or the plurality of second feature line segments Lb is too large, it will cause the area of the first pressure relief hole 111b to be too large. To avoid communication between the first pressure relief hole 111b and the front cavity on the front side of the diaphragm 113, the size of the rear cavity on the rear side of the diaphragm 113 needs to be designed to be relatively large, thereby leading to an excessively large size of the sound output unit 11 and affecting the wearing comfort and portability of the acoustic device 10. In some embodiments, to avoid an excessively large size of the acoustic device 10 and improve the wearing comfort and portability of the acoustic device 10, the maximum length of the plurality of first feature line segments La or the plurality of second feature line segments Lb may be not greater than 1.6 mm, for example, in a range of 1.2 mm to 1.6 mm.

In some embodiments, the part of the effective vent port of the pressure relief hole 111b far away from the sound outlet hole 111a may be a circular arc segment, that is, the ends of the first side wall and the second side wall far away from the sound outlet hole 111a may be connected by the circular arc segment, so as to minimize the impact of sound wave reflection on listening. Exemplarily, as shown in FIG. 6A, at this time, the first side edge and the second side edge of the first projection 111b′ may be connected by the projection of the circular arc segment on the reference plane S, and one endpoint of the first feature line segment La or the second feature line segment Lb with the maximum length may be the connection point between the projection of the circular arc segment and the second side edge.

In some embodiments, on the acoustic device 10, a minimum dimension of the pressure relief hole 111b in the thickness direction X of the sound output unit 11 may be not less than 0.5 mm (e.g., in a range of 0.5 mm to 1 mm), and a maximum dimension may be not greater than 1.6 mm (e.g., in a range of 1.2 mm to 1.6 mm).

In some embodiments, the first side edge of the first projection 111b′ is substantially parallel to the long axis direction Y′ of the projection of the sound output unit 11 on the reference plane S, so that the first side wall of the effective vent port of the pressure relief hole 111b corresponding to the first side edge is substantially parallel to the long axis direction Y of the sound output unit 11. Meanwhile, the effective vent port of the pressure relief hole 111b has a second side wall corresponding to the second side edge, and the relative relationship between the first side wall and the second side wall may be substantially the same as the relative relationship between the first side edge and the second side edge. Hereinafter, the inclination angle of the pressure relief hole 111b relative to the long axis direction Y may refer to an inclination angle of the second side wall of the effective vent port of the pressure relief hole 111b relative to the long axis direction Y.

Referring to FIG. 5, FIG. 6A, and FIG. 6B, in some embodiments, an angle θ₁ between the second side edge and the first side edge may reflect the size of the area of the first projection 111b′, thereby reflecting the size of the area of the effective vent port of the pressure relief hole 111b. Referring to FIG. 5, since the position of the bracket 112 is fixed, that is, the position of the first side wall of the effective vent port of the pressure relief hole 111b is fixed, the larger the angle θ₁ between the second side edge and the first side edge, the larger the inclination angle of the second side wall of the effective vent port of the pressure relief hole 111b relative to the long axis direction Y. In other words, the greater the inclination degree of the pressure relief hole 111b and the effective vent port of the pressure relief hole 111b relative to the long axis direction Y, the larger the part of the pressure relief hole 111b occluded by the bracket 112. Correspondingly, the area of the effective vent port of the pressure relief hole 111b is smaller, resulting in insufficient air permeability of the pressure relief hole 111b. It should be noted that when the second side edge is completely an arc-shaped edge, the angle θ₁ between the second side edge and the first side edge may refer to an angle between a tangent line of a designated point of the second side edge (e.g., the midpoint of the second side edge, etc.) and the first side edge, or an angle between a connecting line of the two endpoints of the second side edge and the first side edge. When the second side edge includes an arc-shaped edge and a straight edge, the angle θ₁ between the second side edge and the first side edge may refer to an angle between a straight edge of the second side edge and the first side edge. In some embodiments, since the minimum length of the plurality of first feature line segments La or the plurality of second feature line segments Lb may be not less than 0.5 mm (e.g., in a range of 0.5 mm to 1 mm), the second side edge may include an arc-shaped edge and a straight edge. The arc-shaped edge may correspond to the projection of the circular arc segment on the reference plane S, the arc-shaped edge is connected to the end of the first side edge relatively close to the second projection, and the straight edge is connected to the end of the first side edge relatively far from the second projection, so as to minimize the formation of relatively sharp corners of the pressure relief hole 111b, thereby avoiding affecting the user's listening effect.

FIG. 7 is a schematic diagram illustrating frequency response curves of an acoustic device corresponding to a pressure relief hole when an angle between a second side edge and a first side edge is different according to some embodiments of the present disclosure.

Referring to FIG. 7, the angle θ₁ between the second side edge and the first side edge corresponding to the curve L₇₁ is set to 0°, that is, both the first side wall and the second side wall of the effective vent port of the pressure relief hole 111b are arranged along the long axis direction Y. At this time, the effective vent port of the pressure relief hole 111b may be arranged in a rectangular shape or a rectangular shape with rounded corners. The angle θ₁ between the second side edge and the first side edge corresponding to the curve L₇₂ is set to 30°, that is, the first side wall of the effective vent port of the pressure relief hole 111b is arranged along the long axis direction Y, and the second side wall is arranged at an angle of 30° with the long axis direction Y. The angle θ₁ between the second side edge and the first side edge corresponding to the curve L₇₃ is set to 45°, that is, the first side wall of the effective vent port of the pressure relief hole 111b is arranged along the long axis direction Y, and the second side wall is arranged at an angle of 45° with the long axis direction Y. The angle θ₁ between the second side edge and the first side edge corresponding to the curve L₇₄ is set to 60°, that is, the first side wall of the effective vent port of the pressure relief hole 111b is arranged along the long axis direction Y, and the second side wall is arranged at an angle of 60° with the long axis direction Y.

As shown in FIG. 7, as the angle θ₁ between the second side edge and the first side edge increases, the resonant frequency of the rear cavity on the rear side of the diaphragm 113 communicated with the pressure relief hole 111b decreases, and the output sound pressure level of the acoustic device 10 in the low frequency range is slightly improved. In some embodiments, to ensure that the resonant frequency of the rear cavity on the rear side of the diaphragm 113 communicated with the pressure relief hole 111b is not less than 3 kHz, so that the acoustic device 10 has a relatively flat output within a relatively wide frequency band range and the output performance of the acoustic device 10 is improved, the inclination angle of the effective vent port of the pressure relief hole 111b relative to the long axis direction Y on the acoustic device 10 may be in a range of 0° to 45°. In some embodiments, to further improve the output performance of the acoustic device 10, the inclination angle of the effective vent port of the pressure relief hole 111b relative to the long axis direction Y may be in a range of 0°to 30°.

While improving the output performance of the acoustic device 10, to ensure sufficient air permeability of the pressure relief hole 111b, the angle θ₁ between the second side edge and the first side edge may be in a range of 0° to 60°. In some embodiments, to avoid an excessively small area of the effective vent port of the pressure relief hole 111b and further ensure sufficient air permeability of the first pressure relief hole 111b, the angle θ₁ between the second side edge and the first side edge may be in a range of 20°to 50°. In some embodiments, to avoid an excessively small area of the effective vent port of the pressure relief hole 111b and further ensure sufficient air permeability of the first pressure relief hole 111b, the angle θ₁ between the second side edge and the first side edge may be in a range of 30° to 45°.

Referring to FIG. 6A and FIG. 6B, in some embodiments, when the first projection 111b′ is located on the same side of the second projection in the long axis direction Y′, the first projection 111b′ may have a first end closer to the second projection and a second end opposite to the first end in the long axis direction Y′, and the first end is provided with a first feature point Pb closest to the second projection. In some embodiments, the first feature point Pb may be determined based on the center point M₁ of the second projection. In some embodiments, when the second projection is a line segment, the first feature point Pb may be determined based on an endpoint of the second projection close to the first projection 111b′.

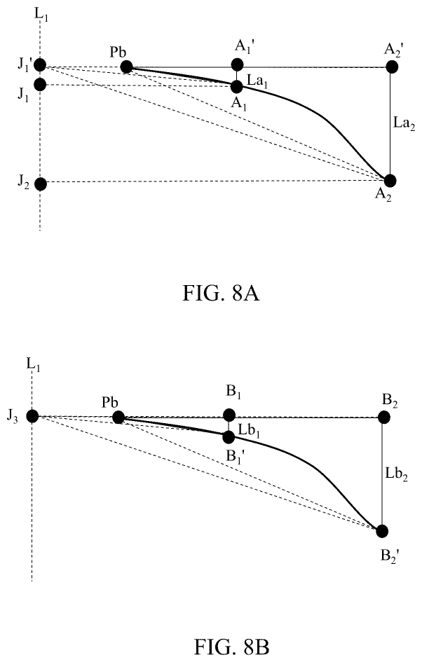

FIG. 8A is a schematic diagram illustrating positions of a first reference point and a second reference point according to some embodiments of the present disclosure. Referring to FIG. 8A, in some embodiments, a first feature length exists between the first reference point A₁ and the first feature point Pb, and a ratio of the first length of the first sub-line segment La₁ to the first feature length is a first length ratio. In a triangle A₁′PbA₁ formed by the first feature point Pb and two endpoints (endpoint A₁′ and first reference point A₁) of the first sub-line segment La₁, a value of sin ∠A₁′PbA₁ of an angle corresponding to the first feature point Pb (i.e., ∠A₁′PbA₁) is the first length ratio. A second feature length exists between the second reference point A₂ and the first feature point Pb, and a ratio of the second length of the second sub-line segment La₂ to the second feature length is a second length ratio. In some embodiments, in a triangle A₂′A₂Pb formed by the first feature point Pb and two endpoints (endpoint A₂′ and second reference point A₂) of the second sub-line segment La₂, a value of sin ∠A₂′PbA₂ of an angle corresponding to the first feature point Pb (i.e., ∠A₂′PbA₂) is the second length ratio.

In some embodiments, the first length ratio may be greater than the second length ratio, so as to ensure that the length of the first feature line segment La increases as the distance from the reference point to the second projection increases, while avoiding an excessively large size of the first projection 111b′. Thus, sufficient air permeability of the pressure relief hole 111b is ensured while avoiding sound wave interference as much as possible; at the same time, the pressure relief hole 111b is prevented from being excessively large, which may lead to an excessively large size of the sound output unit 11 and affect the wearing comfort and portability of the acoustic device 10. Specifically, point Pb, point A₁′, and point A₂′ are collinear (i.e., point Pb, point A₁′, and point A₂′ are all located on the first side edge), and the first sub-line segment La₁ (i.e., the connecting line A₁ A₁′) is perpendicular to the connecting line PbA₁′, and the second sub-line segment La₂ (i.e., the connecting line A₂A₂′) is perpendicular to the connecting line PbA₁′. When the first reference point A₁ is located outside the triangle A₂A₂′Pb, it indicates that ∠A₁PbA₁′ is greater than ∠A₂PbA₂′, that is, the first length ratio is greater than the second length ratio, as shown in FIG. 6A. At this time, the curvature change of the second side edge of the first projection 111b′ is relatively gentle; in other words, the curvature change of the second side wall of the effective vent port of the pressure relief hole 111b is relatively gentle. Specifically, compared with the connecting line of the two endpoints of the second side edge, the second side edge protrudes downward, so as to reduce the processing difficulty of the pressure relief hole 111b.

In some examples, the first length ratio may be equal to the second length ratio. At this time, the first projection may be a regular triangular structure or a rectangular structure, that is, the connecting line of the two endpoints of the second side edge is the second side edge. Specifically, when the first reference point A₁ is located on the hypotenuse A₂Pb of the triangle A₂A₂′Pb, it indicates that ∠A₁PbA₁′ is equal to ∠A₂PbA₂′, that is, the first length ratio is equal to the second length ratio.

In some embodiments, the curvature change of the second side edge of the first projection 111b′ is relatively sharp; in other words, the curvature change of the second side wall of the effective vent port of the pressure relief hole 111b is relatively sharp, as shown in FIG. 8A. At this time, when the first reference point A₁ is located inside the triangle A₂A₂′Pb, it indicates that ∠A₁PbA₁′ is less than ∠A₂PbA₂′, that is, the first length ratio is less than the second length ratio. Specifically, compared with the connecting line of the two endpoints of the second side edge, the second side edge protrudes upward. Thus, among the plurality of first feature line segments La, the length of a first feature line segment La farther from the second projection changes more sharply and increases more, so that the part of the first projection 111b′ farther from the second projection has a larger size increase. Further, the center of the first projection 111b′ is farther from the second projection, and the pressure relief hole 111b is farther from the sound outlet hole 111a, avoiding the acoustic short-circuit.

FIG. 8B is a schematic diagram illustrating positions of a third reference point and a fourth reference point according to some embodiments of the present disclosure. Referring to FIG. 8B, a third feature length exists between the third reference point B₁ and the first feature point Pb, and a ratio of the third length of the third sub-line segment Lb₁ to the third feature length is a third length ratio. In a triangle B₁B₁′Pb formed by the first feature point Pb and two endpoints of the third sub-line segment Lb₁ (e.g., one endpoint is the third reference point B₁, and the other endpoint is point B₁′), a value of tan ∠B₁PbB₁′ of an angle corresponding to the first feature point Pb (i.e., ∠B₁PbB₁′) is the third length ratio. A fourth feature length exists between the fourth reference point B₂ and the first feature point Pb, and a ratio of the fourth length of the fourth sub-line segment Lb₂ to the fourth feature length is a fourth length ratio. In some embodiments, in a triangle B₂B₂′Pb formed by the first feature point Pb and two endpoints of the fourth sub-line segment Lb₂ (e.g., one endpoint is the fourth reference point B₂, and the other endpoint is point B₂′), a value of tan ∠B₂PbB₂′ of an angle corresponding to the first feature point Pb (i.e., ∠B₂PbB₂′) is the fourth length ratio.

In some embodiments, the third length ratio may be greater than the fourth length ratio, so as to ensure that the length of the second feature line segment Lb increases as the distance from the reference point to the center of the second projection increases, while avoiding an excessively large size of the first projection 111b′. Thus, sufficient air permeability of the pressure relief hole 111b is ensured while avoiding sound wave interference as much as possible; at the same time, the pressure relief hole 111b is prevented from being excessively large, which may lead to an excessively large size of the sound output unit 11 and affect the wearing comfort and portability of the acoustic device 10. Specifically, point Pb, point B₁, and point B₂ are collinear (i.e., point Pb, point B₁, and point B₂ are all located on the first side edge), the third sub-line segment Lb₁ (i.e., the connecting line B₁B₁′) is perpendicular to the connecting line PbB₁, and the fourth sub-line segment Lb₂ (i.e., the connecting line B₂B₂′) is perpendicular to the connecting line PbB₂. When the point B₁′ is located outside the triangle B₂B₂′Pb, it indicates that ∠B₁PbB₁′ is greater than ∠B₂PbB₂′, that is, the third length ratio is greater than the fourth length ratio, as shown in FIG. 6B. At this time, the curvature change of the second side edge of the first projection 111b′ is relatively gentle. Specifically, compared with the connecting line of the two endpoints of the second side edge, the second side edge protrudes downward. In other words, the curvature change of the second side wall of the effective vent port of the pressure relief hole 111b is relatively gentle, so as to reduce the processing difficulty of the pressure relief hole 111b.

In some examples, the third length ratio may be equal to the fourth length ratio. At this time, the first projection may be a regular triangular structure or a rectangular structure, that is, the connecting line of the two endpoints of the second side edge is the second side edge.

Specifically, when the point B₁′ is located on the hypotenuse B₂′Pb of the triangle B₂B₂′Pb, it indicates that ∠B₁PbB₁′ is equal to ∠B₂PbB₂′, that is, the third length ratio is equal to the fourth length ratio.

In some embodiments, the curvature change of the second side edge of the first projection 111b′ is relatively sharp; in other words, the curvature change of the second side wall of the effective vent port of the pressure relief hole 111b is relatively sharp, as shown in FIG. 8B. When the point B₁′ is located inside the triangle B₂B₂′Pb, it indicates that ∠B₁PbB₁′ is less than ∠B₂PbB₂′, that is, the third length ratio is less than the fourth length ratio, as shown in FIG. 8B. Specifically, compared with the connecting line of the two endpoints of the second side edge, the second side edge protrudes upward. Thus, among the plurality of second feature line segments Lb, the length of a second feature line segment Lb farther from the second projection changes more sharply and increases more. Therefore, the part of the first projection 111b′ farther from the center of the second projection has a larger size increase, further making the center of the first projection 111b′ farther from the center of the second projection, and the pressure relief hole 111b farther from the sound outlet hole 111a, avoiding the acoustic short-circuit.

In some embodiments, the farther the part of the pressure relief hole 111b is from the sound outlet hole 111a, the greater the magnitude of the size increase, so that the center of the pressure relief hole 111b is farther from the sound outlet hole 111a, ensuring the pressure relief hole 111b is far from the sound outlet hole 111a and avoiding the acoustic short-circuit. In some embodiments, the closer the part of the pressure relief hole 111b is to the sound outlet hole 111a, the smaller the magnitude of the size decrease or the size decreases in a linear magnitude, so that the pressure relief hole 111b has a relatively large area and sufficient air permeability is ensured.

In some embodiments, as shown in FIG. 4A and FIG. 4B, the sound outlet hole 111a may be disposed closer to the free end FE than to the connection end CE, so that in the wearing state, the sound outlet hole 111a is closer to the ear canal of the user, enabling sound output from the front side of the diaphragm 113 of the sound output unit 11 to be better transmitted to the ear canal of the user and improving the user's listening volume.

In some embodiments, as shown in FIG. 6A, in the long axis direction Y′, the first reference point A₁ is closer to a center point H₁ of a projection of the free end FE on the reference plane S than the second reference point A₂. In some embodiments, as shown in FIG. 6B, in the long axis direction Y′, the third reference point B₁ is closer to the center point H₁ of the projection of the free end FE on the reference plane S than the fourth reference point B₂. That is, the end of the first projection 111b′ closer to the projection of the free end FE has a smaller size, and the end farther from the projection of the free end FE has a larger size. Correspondingly, the part of the effective vent port of the pressure relief hole 111b close to the free end FE has a narrow size, and the part far from the free end FE has a wide size. Since the sound outlet hole 111a is closer to the free end FE relative to the connection end CE, the effective vent port of the pressure relief hole 111b is far from the sound outlet hole 111a while sufficient air permeability of the pressure relief hole 111b is ensured. The distance from a reference point of the first projection 111b′ (e.g., the reference point A, the reference point B) to the center of the projection of the free end FE may also be equivalently replaced with a distance from the reference point of the first projection 111b′ (e.g., the reference point A, the reference point B) to the projection of the center (e.g., the centroid) of the free end FE. In some embodiments, when the free end FE is a plane, the projection of the free end FE on the reference plane S is a straight line segment, and the center point H₁ may be the midpoint of the straight line segment. In some embodiments, when the free end FE is a curved surface, the projection of the free end FE on the reference plane S is an arc segment, and the center point H₁ may be the midpoint of the arc segment or the point on the arc segment farthest from the connecting line of the two ends of the arc segment. Specifically, in the long axis direction Y′, the distance from the reference point to the center point H₁ of the projection of the free end FE on the reference plane S may refer to a distance from the reference point to a straight line passing through the center point H₁ and perpendicular to the long axis direction Y′.

In some embodiments, a distance between the first reference point A₁ and the center point H₁ of the projection of the free end FE on the reference plane S in the long axis direction Y′ is a fifth feature length, and a ratio of the first length of the first sub-line segment La₁ to the fifth feature length is a fifth length ratio. Since the first side edge is parallel to the long axis direction Y′ and the first feature line segment La is perpendicular to the inner side surface IS, the first feature line segment La is perpendicular to the first side edge. Specifically, a straight line L₁ perpendicular to the long axis direction Y′ is drawn through point H₁. A distance from the first reference point A₁ to point H₁ in the long axis direction Y′ may refer to a distance from the first reference point A₁ to the straight line L₁, and the distance from the first reference point A₁ to the straight line L₁ is equal to a distance from another endpoint A₁′ of the first sub-line segment La₁ to the straight line L₁. For example, a perpendicular line to the straight line L₁ may be drawn through the first reference point A₁, intersecting the straight line L₁ at a point J₁, and a length of the line segment A₁J₁ is the distance between the first reference point A₁ and the straight line L₁; similarly, a perpendicular line to the straight line L₁ may be drawn through point A₁′, intersecting the straight line L₁ at a point J₁′, and a length of the line segment A₁′J₁′ is the distance between endpoint A₁′ and the straight line L₁, where point J₁′ is the foot of the perpendicular from the first side edge to the straight line L₁. At this time, the length of A₁′J₁′ is equal to the length of the line segment A₁J₁, and the length of the line segment A₁′J₁′ may also serve as the fifth feature length. In the triangle A₁J₁A₁′ formed by the point J₁ and two endpoints (the first reference point A₁ and the endpoint A₁′) of the first sub-line segment La₁, a value of tan ∠A₁J₁A₁′ of an angle corresponding to point J₁ (i.e., ∠A₁J₁A₁′) is the fifth length ratio; similarly, a value of tan ∠A₁J₁′A₁′ of an angle ∠A₁J₁′A₁′ corresponding to the point J₁′ may also be the fifth length ratio.

Similarly, a distance from the second reference point A₂ to the straight line L₁ is equal to a distance from point A₂′ to the straight line L₁. A perpendicular line to the straight line L₁ is drawn through the second reference point A₂, intersecting the straight line L₁ at a point J₂, and a length of the line segment A₂J₂ is the distance between the second reference point A₂ and the straight line L₁; since the first side edge is parallel to the long axis direction Y′, the point J₂, point A₁′, and point A₂′ are collinear, so the length of the line segment A₂′J₁′ is equal to the length of the line segment A₂J₂, and the length of the line segment A₂J₂ or the line segment A₂′J₁′ may serve as a sixth feature length. In the triangle A₂J₂A₂′ formed by the point J₂ and two endpoints (the second reference point A₂ and the endpoint A₂′) of the second sub-line segment La₂, tan ∠A₂J₂A₂′ of an angle corresponding to point J₂ (i.e., ∠A₂J₂A₂′) is a sixth length ratio; similarly, a value of tan ∠A₂J₁′A₂′ of an angle ∠A₂J₁′A₂′ corresponding to the point J₁′ may also be the sixth length ratio.

In some embodiments, as shown in FIG. 6A or FIG. 8A, the fifth length ratio is less than the sixth length ratio. Thus, among the plurality of first feature line segments La, the farther from the center point H₁ of the projection of the free end FE, the faster the length of the first feature line segment La increases. Further, the part of the first projection 111b′ farther from the projection of the free end FE has a larger magnitude of size increase; in other words, the part of the effective vent port of the pressure relief hole 111b farther from the sound outlet hole 111a has a larger size, so as to avoid the acoustic short-circuit as much as possible. The distance between the first feature line segment La and the center point H₁ of the projection of the free end FE refers to the distance between the reference point A of the first feature line segment La and the center point H₁ of the projection of the free end FE in the long axis direction Y′.

In some embodiments, the fifth length ratio may be equal to the sixth length ratio. At this time, the second side edge may be a straight line segment, and the straight line segment points to the foot of the perpendicular J₁′ from the first side edge to the straight line L₁. In some embodiments, the fifth length ratio may be greater than the sixth length ratio. Thus, the part of the first projection 111b′ close to the free end has a larger size, ensuring sufficient air permeability of the pressure relief hole 111b.

In some embodiments, a distance between the third reference point B₁ and the center point H₁ of the projection of the free end FE on the reference plane S in the long axis direction Y′ is a seventh feature length, and a ratio of the third length of the third sub-line segment Lb₁ to the seventh feature length is a seventh length ratio. Since the first side edge is parallel to the long axis direction Y′ and the second feature line segment Lb is perpendicular to the inner side surface IS, the second feature line segment Lb is perpendicular to the first side edge. In some embodiments, a straight line L₁ perpendicular to the long axis direction Y′ is drawn through point H₁, and the distance from the third reference point B₁ to point H₁ in the long axis direction Y′ may refer to a distance from the third reference point B₁ to the straight line L₁. For example, a perpendicular line to the straight line L₁ may be drawn through the third reference point B₁ of the third sub-line segment Lb₁, intersecting the straight line L₁ at a point J₃, and a length of the line segment B₁J₃ is a distance between the third reference point B₁ and the straight line L₁, and the length of the line segment B₁J₃ is the seventh feature length. In the triangle B₁J₃B₁′ formed by the point J₃ and two endpoints (the third reference point B₁ and the endpoint B₁′) of the third sub-line segment Lb₁, a value of tan ∠B₁J₃B₁′ of an angle ∠B₁J₃B₁′ corresponding to the point J₃ is the seventh length ratio. In some embodiments, a distance between the fourth reference point B₂ and the center point H₁ of the projection of the free end FE on the reference plane S in the long axis direction Y′ is an eighth feature length. Since the first side edge is parallel to the long axis direction Y′, the point J₃, the third reference point B₁, and the fourth reference point B₂ are collinear (i.e., the point J₃, point B₁, and point B₂ are all located on the first side edge), so a length of the line segment B₂J₃ is an eighth feature length. In the triangle B₂J₃B₂′ formed by point J₃ and two endpoints (the fourth reference point B₂ and the endpoint B₂′) of the fourth sub-line segment Lb₂, a value of tan ∠B₂J₃B₂′ of an angle ∠B₂J₃B₂′ corresponding to the point J₃ is an eighth length ratio.

In some embodiments, as shown in FIG. 6B or FIG. 8B, the seventh length ratio is less than the eighth length ratio. Thus, among the plurality of second feature line segments Lb, the farther from the center point H₁ of the projection of the free end FE, the faster the length of the second feature line segment Lb increases. Further, the part of the first projection 111b′ farther from the projection of the free end FE has a larger magnitude of size increase; in other words, the part of the effective vent port of the pressure relief hole 111b farther from the sound outlet hole 111a has a larger size, so as to avoid the acoustic short-circuit as much as possible. The distance between the second feature line segment Lb and the center point H₁ of the projection of the free end FE refers to the distance between the reference point B of the second feature line segment Lb and the center point H₁ of the projection of the free end FE in the long axis direction Y′.

In some embodiments, the seventh length ratio may be equal to the eighth length ratio. At this time, the second side edge may be a straight line segment, and the straight line segment points to the foot of the perpendicular J₁′ from the first side edge to the straight line L₁. In some embodiments, the seventh length ratio may be greater than the eighth length ratio. Thus, the part of the first projection 111b′ close to the free end has a larger size, ensuring sufficient air permeability of the pressure relief hole 111b.

In some embodiments, the farther the part of the pressure relief hole 111b is from the free end FE, the larger the size increase, so that the centroid of the pressure relief hole 111b is farther from the sound outlet hole 111a, ensuring the pressure relief hole 111b is far from the sound outlet hole 111a to avoid the acoustic short-circuit as much as possible.

In some embodiments, in the long axis direction Y′, the first projection 111b′ has two endpoints that are farthest apart (e.g., a point Qb₁ and a point Qb₂ shown in FIG. 6A and FIG. 6B). One of the plurality of second feature line segments Lb that passes through the midpoint of the two farthest endpoints (i.e., a midpoint Qb₃ of the connecting line between the point Qb₁ and the point Qb₂) divides the first projection 111b′ into two parts, such as the left region (closer to the second projection) and the right region (farther from the second projection) of the first feature line segment La passing through the point Qb₃ in FIG. 6A. The region enclosed by the part of the first projection 111b′ closer to the second projection (e.g., the center point M₁ of the second projection) has a first area, and another region enclosed by the part farther from the second projection (e.g., the center point M₁ of the second projection) has a second area. In some embodiments, the first area may be less than the second area; in other words, the ratio of the first area to the second area may be less than 1. Thus, the part of the first projection 111b′ closer to the second projection has a smaller size, and the part of the first projection 111b′ farther from the second projection has a larger size; in other words, the part of the effective vent port of the pressure relief hole 111b close to the sound outlet hole 111a is narrow, and the part far from the sound outlet hole 111a is wide. Further, the effective vent port of the pressure relief hole 111b is as far away from the sound outlet hole 111a as possible, while sufficient air permeability of the pressure relief hole 111b is ensured.

If the ratio of the first area to the second area is too small, the first area may be too small or the second area may be too large. When the first area is too small, it may cause the effective vent port of the pressure relief hole 111b to form a relatively sharp corner near the sound outlet hole 111a, thereby leading to reflection of sound with a short wavelength and introduction of noise, affecting the output performance of the acoustic device 10. If the second area is too large, it will cause the size of the sound output unit 11 to be excessively large, affecting the wearing comfort of the acoustic device 10. If the ratio of the first area to the second area is too large, the first area may be too large or the second area may be too small, causing the centroid of the pressure relief hole 111b to be close to the sound outlet hole 111a and resulting in the acoustic short-circuit.

In some embodiments, to improve the output performance and wearing comfort of the acoustic device 10 while avoiding the acoustic short-circuit, the ratio of the first area to the second area may be in a range of 0.5 to 0.99. In some embodiments, to further improve the output performance and wearing comfort of the acoustic device 10, the ratio of the first area to the second area may be in a range of 0.55 to 0.96. In some embodiments, to further avoid the acoustic short-circuit, the ratio of the first area to the second area may be in a range of 0.45 to 0.7.

In some embodiments, the effective vent port of the pressure relief hole 111b may have two endpoints that are farthest apart in the long axis direction Y. A line segment passing through the midpoint of the two endpoints and perpendicular to the inner side surface IS divides the effective vent port into two parts. Among the aforementioned two parts, the area of the region enclosed by the part closer to the sound outlet hole 111a is smaller than the area of the region enclosed by the part farther from the sound outlet hole 111a. Thus, the part of the effective vent port of the pressure relief hole 111b close to the sound outlet hole 111a has a smaller size, and the part far from the sound outlet hole 111a has a larger size. Further, the effective vent port of the pressure relief hole 111b is far from the sound outlet hole 111a while sufficient air permeability of the pressure relief hole 111b is ensured.

To improve the output performance and wearing comfort of the acoustic device 10 while avoiding the acoustic short-circuit, the ratio of the area of the region enclosed by the part of the effective vent port of the pressure relief hole 111b closer to the sound outlet hole 111a to the area of the region enclosed by the part farther from the sound outlet hole 111a may be in a range of 0.5 to 0.99.

In some embodiments, if the dimension of the first projection 111b′ in the long axis direction Y′ is too small, it may lead to an excessively small area of the effective vent port of the pressure relief hole 111b, resulting in a small resonant frequency of the rear cavity on the rear side of the diaphragm 113 communicated with the pressure relief hole 111b and affecting the output performance of the acoustic device 10. Meanwhile, the excessively small area of the effective vent port of the pressure relief hole 111b may also result in insufficient air permeability of the pressure relief hole 111b, which is prone to generating standing waves and affecting the output performance of the acoustic device 10. If the dimension of the first projection 111b′ in the long axis direction Y′ is too large, it may lead to the effective vent port of the pressure relief hole 111b being too narrow and long, resulting in a relatively large acoustic resistance at the effective vent port of the pressure relief hole 111b. This makes the resonant frequency of the rear cavity on the rear side of the diaphragm 113 communicated with the pressure relief hole 111b small, affecting the output performance of the acoustic device 10. At the same time, the excessively large dimension of the first projection 111b′ in the long axis direction Y may lead to an excessively large size of the sound output unit 11, affecting the wearing comfort of the acoustic device 10. The dimension of the first projection 111b′ in the long axis direction Y′ may refer to the length of the connecting line between the aforementioned point Qb₁ and point Qb₂, or may refer to the length of the connecting line between the two points of the first projection 111b′ that are closest to and farthest from the second projection (e.g., the center M₁ of the second projection) in the long axis direction Y′. In some embodiments, to improve the output performance and wearing comfort of the acoustic device 10, the distance between the two farthest endpoints of the first projection 111b′ in the long axis direction Y′ may be in a range of 4 mm to 6 mm, that is, the dimension of the first projection 111b′ in the long axis direction Y′ may be in a range of 4 mm to 6 mm. In some embodiments, to further improve the output performance and wearing comfort of the acoustic device 10, the dimension of the first projection 111b′ in the long axis direction Y′ may be in a range of 4.3 mm to 5.5 mm.

In some embodiments, to improve the output performance and wearing comfort of the acoustic device 10, the dimension of the effective vent port of the pressure relief hole 111b in the long axis direction Y may be in a range of 4 mm to 6 mm. The dimension of the pressure relief hole 111b in the long axis direction Y may refer to the length of the connecting line between the two farthest endpoints of the effective vent port of the aforementioned pressure relief hole 111b in the long axis direction Y.

Referring to FIGS. 4A-8B, in some embodiments, the pressure relief hole 111b may include the first pressure relief hole 111b-1 disposed on the upper side surface US. It should be noted that when the first pressure relief hole 111b-1 is disposed at an edge or arc transition region where the upper side surface US intersects with other side surfaces (e.g., the inner side surface IS), the first pressure relief hole 111b-1 may also be considered to be located on the upper side surface US. In some embodiments, the distance between the first pressure relief hole 111b-1 and the sound outlet hole 111a may be in a range of 12 mm to 15 mm. In some embodiments, to further avoid the acoustic short-circuit, the distance between the first pressure relief hole 111b-1 and the sound outlet hole 111a may be in a range of 12.5 mm to 13.5 mm. Exemplarily, the distance between the first pressure relief hole 111b-1 and the sound outlet hole 111a may be 12.8 mm, 13 mm, 14 mm, or 14.5 mm.

In some embodiments, the length of the first feature line segment La or the second feature line segment Lb of the projection 111b-1′of the effective vent port of the first pressure relief hole 111b-1 on the reference plane S (e.g., the first reference plane S₁) may be in a range of 0.5 mm to 1.6 mm. In some embodiments, the angle θ₁ between the second side edge and the first side edge of the projection 111b-1′of the effective vent port of the first pressure relief hole 111b-1 on the first reference plane S₁ may be in a range of 0°to 60°. Exemplarily, the angle θ₁ between the second side edge and the first side edge of the projection 111b-1′of the effective vent port of the first pressure relief hole 111b-1 on the first reference plane S₁ may be 35°. In some embodiments, the ratio of the first area to the second area of the projection 111b-1′of the effective vent port of the first pressure relief hole 111b-1 on the first reference plane S₁ may be in a range of 0.5 to 0.7. Exemplarily, the ratio of the first area to the second area of the projection 111b-1′of the effective vent port of the first pressure relief hole 111b-1 on the first reference plane S₁ may be 0.6. In some embodiments, the distance between the two farthest endpoints of the projection 111b-1′in the long axis direction Y′ may be in a range of 5 mm to 6 mm, that is, the dimension of the projection 111b-1′of the effective vent port of the first pressure relief hole 111b-1 on the first reference plane S₁ in the long axis direction Y′ may be in a range of 5 mm to 6 mm. Exemplarily, the dimension of the projection 111b-1′of the effective vent port of the first pressure relief hole 111b-1 on the first reference plane S₁ in the long axis direction Y′ may be 5.5 mm.

In some embodiments, the dimension of the effective vent port of the first pressure relief hole 111b-1 in the thickness direction X of the sound output unit 11 may be in a range of 0.5 mm to 1.6 mm. In some embodiments, the ratio of the area of the region enclosed by the part of the effective vent port of the first pressure relief hole 111b-1 closer to the sound outlet hole 111a to the area of the region enclosed by the part farther from the sound outlet hole 111a may be in a range of 0.5 to 0.7. In some embodiments, the dimension of the effective vent port of the first pressure relief hole 111b-1 in the long axis direction Y may be in a range of 5 mm to 6 mm.

In some embodiments, the pressure relief hole 111b may further include the second pressure relief hole 111b-2 disposed on the lower side surface LS of the housing 111, as shown in FIG. 4A and FIG. 4B. The second pressure relief hole 111b-2 is configured to guide the sound generated at the rear side of the diaphragm 113 out of the housing 111. It should be noted that when the second pressure relief hole 111b-2 is disposed at an edge or arc transition region where the lower side surface LS intersects with other side surfaces (e.g., the inner side surface IS), the second pressure relief hole 111b-2 may also be considered to be located on the lower side surface LS. In some embodiments, the pressure relief hole 111b may include only one of the first pressure relief hole 111b-1 or the second pressure relief hole 111b-2, or may include both the first pressure relief hole 111b-1 and the second pressure relief hole 111b-2.

FIG. 9 is a schematic diagram illustrating of an exemplary structure of a second pressure relief hole according to some embodiments of the present disclosure. FIGS. 10A and 10B are schematic diagrams illustrating positions of different reference points according to some embodiments of the present disclosure.

In some embodiments, to avoid the acoustic short-circuit, the effective vent port of the second pressure relief hole 111b-2 needs to be far from the sound outlet hole 111a, and the distance between the effective vent port of the second pressure relief hole 111b-2 and the sound outlet hole 111a may be in a range of 15 mm to 20 mm. In some embodiments, to further avoid the acoustic short-circuit, the distance between the effective vent port of the second pressure relief hole 111b-2 and the sound outlet hole 111a may be in a range of 16 mm to 18 mm. Exemplarily, the distance between the effective vent port of the second pressure relief hole 111b-2 and the sound outlet hole 111a may be 17 mm.

In some embodiments, when the pressure relief hole 111b includes both the first pressure relief hole 111b-1 and the second pressure relief hole 111b-2, the distance between the effective vent port of the first pressure relief hole 111b-1 and the sound outlet hole 111a may be less than the distance between the effective vent port of the second pressure relief hole 111b-2 and the sound outlet hole 111a. The distance between the effective vent port of the first pressure relief hole 111b-1 and the sound outlet hole 111a may refer to a distance between a center point B of the effective vent port of the first pressure relief hole 111b-1 and the center point M of the sound outlet hole 111a. The distance between the effective vent port of the second pressure relief hole 111b-2 and the sound outlet hole 111a may refer to a distance between a center point C of the effective vent port of the second pressure relief hole 111b-2 and the center point M of the sound outlet hole 111a, as shown in FIG. 4A and FIG. 4B.

Referring to FIG. 9, FIG. 10A, and FIG. 10B, in some embodiments, the reference plane S (e.g., the first reference plane S₁) of the first pressure relief hole 111b-1 and the reference plane S (e.g., the second reference plane S₂) of the second pressure relief hole 111b-2 may be the same or different. Specifically, the second reference plane S₂ of the second pressure relief hole 111b-2 may be parallel or tangent to the side surface where the effective vent port of the second pressure relief hole 111b-2 is located. Exemplarily, the second pressure relief hole 111b-2 is disposed on the lower side surface LS. When the lower side surface LS is a plane, the second reference plane S₂ may be parallel to the lower side surface LS, or the plane where the lower side surface LS is located is the second reference plane S₂. When the lower side surface LS is a curved surface, the second reference plane S₂ may be tangent to the lower side surface LS. In some embodiments, the second reference plane S₂ may also be perpendicular to the inner side surface IS. In some embodiments, the first reference plane S₁ of the first pressure relief hole 111b-1 is parallel to the second reference plane S₂ of the second pressure relief hole 111b-2. In some embodiments, the first reference plane S₁ and the second reference plane S₂ may be the same plane.

In some embodiments, the length of the first feature line segment La or the second feature line segment Lb of the projection 111b-2′of the effective vent port of the second pressure relief hole 111b-2 on the reference plane S (e.g., the second reference plane S₂) may be in a range of 1 mm to 1.6 mm. In some embodiments, an angle θ₂ between the second side edge and the first side edge of the projection 111b-2′of the effective vent port of the second pressure relief hole 111b-2 on the second reference plane S₂ may be in a range of 0°to 60°. Exemplarily, the angle θ₂ between the second side edge and the first side edge of the projection 111b-2′of the effective vent port of the second pressure relief hole 111b-2 on the second reference plane S₂ may be 35°. In some embodiments, the ratio of the first area to the second area of the projection 111b-2′of the effective vent port of the second pressure relief hole 111b-2 on the second reference plane S₂ may be in a range of 0.7 to 0.99. Exemplarily, the ratio of the first area to the second area of the projection 111b-2′of the effective vent port of the second pressure relief hole 111b-2 on the second reference plane S₂ may be 0.9. In some embodiments, the distance between the two farthest endpoints of the projection 111b-2′in the long axis direction Y′ may be in a range of 4 mm to 5 mm, that is, the dimension of the projection 111b-2′of the effective vent port of the second pressure relief hole 111b-2 on the second reference plane S₂ in the long axis direction Y′ may be in a range of 4 mm to 5 mm. Exemplarily, the dimension of the projection 111b-2′of the effective vent port of the second pressure relief hole 111b-2 on the second reference plane S₂ in the long axis direction Y′ may be 4.5 mm.

In some embodiments, the dimension of the effective vent port of the second pressure relief hole 111b-2 in the thickness direction X of the sound output unit 11 may be in a range of 1 mm to 1.6 mm. In some embodiments, the ratio of the area of the region enclosed by the part of the effective vent port of the second pressure relief hole 111b-2 closer to the sound outlet hole 111a to the area of the region enclosed by the part farther from the sound outlet hole 111a may be in a range of 0.7 to 0.99. In some embodiments, the dimension of the effective vent port of the second pressure relief hole 111b-2 in the long axis direction Y may be in a range of 4 mm to 5 mm.

Referring to FIG. 4A and FIG. 4B, since the installation position of the second pressure relief hole 111b-2 may be farther from the sound outlet hole 111a than the first pressure relief hole 111b-1, the relative size relationship between the area of the region enclosed by the part of the effective vent port of the second pressure relief hole 111b-2 closer to the sound outlet hole 111a and the area of the region enclosed by the part farther from the sound outlet hole 111a has little impact on the distance between the center of the effective vent port of the second pressure relief hole 111b-2 and the sound outlet hole 111a. The possibility of generating an acoustic short-circuit between the second pressure relief hole 111b-2 and the sound outlet hole 111a is smaller than the possibility of generating an acoustic short-circuit between the first pressure relief hole 111b-1 and the sound outlet hole 111a. In some embodiments, the ratio of the first area to the second area of the projection 111b-1′is a first area ratio, the ratio of the first area to the second area of the projection 111b-2′is a second area ratio, and the first area ratio may be less than the second area ratio. Correspondingly, the ratio of the first area to the second area of the effective vent port of the first pressure relief hole 111b-1 may be less than the ratio of the first area to the second area of the effective vent port of the second pressure relief hole 111b-2. In some embodiments, the ratio of the first area to the second area of the effective vent port of the second pressure relief hole 111b-2 may be greater than, less than, or equal to 1; that is, in the effective vent port of the second pressure relief hole 111b-2, the area of the region enclosed by the part closer to the sound outlet hole 111a may also be greater than, less than, or equal to the area of the region enclosed by the part farther from the sound outlet hole 111a.

Basic concepts have been described above. Obviously, for those skilled in the art, the above detailed disclosure is merely provided as examples and does not constitute limitations on the present disclosure. Although not explicitly stated herein, those skilled in the art may make various modifications, improvements, and corrections to the present disclosure. Such modifications, improvements, and corrections are suggested in the present disclosure, so such modifications, improvements, and corrections still fall within the spirit and scope of the exemplary embodiments of the present disclosure.

Meanwhile, the present disclosure uses specific words to describe the embodiments of the present disclosure. For example, “one embodiment”, “an embodiment”, and/or “some embodiments” mean a certain feature, structure, or characteristic related to at least one embodiment of the present disclosure. Therefore, it should be emphasized and noted that “an embodiment” or “one embodiment” or “an alternative embodiment” mentioned twice or more at different positions in the present specification do not necessarily refer to the same embodiment. In addition, certain features, structures, or characteristics in one or more embodiments of the present disclosure may be appropriately combined.

Similarly, it should be noted that to simplify the expression of the disclosure of the present disclosure and thereby facilitate the understanding of one or more invention embodiments, in the foregoing description of the embodiments of the present disclosure, multiple features are sometimes incorporated into a single embodiment, accompanying drawing, or description thereof. However, this disclosure method does not imply that the object of the present disclosure requires more features than those mentioned in the claims. In fact, the features of an embodiment are fewer than all the features of the single embodiment disclosed above.

In some embodiments, numbers describing the quantity of components or attributes are used. It should be understood that such numbers used for describing the embodiments are modified by the modifiers “about”, “approximately”, or “substantially”in some examples.

Unless otherwise stated, “about”, “approximately”, or “substantially” indicates that the stated number allows a variation of ±20%. Correspondingly, in some embodiments, the numerical parameters used in the specification and claims are approximate values, and the approximate values may change according to the required characteristics of individual embodiments. In some embodiments, the numerical parameters should take into account the specified significant digits and adopt a general digit retention method. Although the numerical ranges and parameters used to confirm the breadth of the scope in some embodiments of the present disclosure are approximate values, in specific embodiments, the setting of such numerical values is as precise as possible within the feasible range.

Finally, it should be understood that the embodiments described in the present disclosure are merely intended to illustrate the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Correspondingly, the embodiments of the present disclosure are not limited to the embodiments explicitly introduced and described in the present disclosure.

1. An acoustic device, comprising:
a sound output unit, including a housing and a diaphragm accommodated in the housing, the diaphragm being configured to generate a sound through vibration;
a suspension structure, configured to position the sound output unit near an ear canal of a user without blocking the ear canal, wherein,
in a wearing state, an inner side surface of the housing facing an auricle of the user is provided with a sound outlet hole, the sound outlet hole is configured to guide a sound generated at a front side of the diaphragm out of the housing; side surfaces of the housing other than the inner side surface are provided with one or more pressure relief holes, and the one or more pressure relief holes are configured to guide a sound generated at a rear side of the diaphragm out of the housing; wherein,
each of the one or more pressure relief holes includes an effective vent port, the effective vent port has a first projection on a reference plane, the reference plane is parallel or tangent to a side surface where the effective vent port is located, the reference plane is perpendicular to the inner side surface, the first projection defines a plurality of first feature line segments that are perpendicular to the inner side surface, two endpoints of each of the plurality of first feature line segments are located on a contour of the first projection, and the plurality of first feature line segments are parallel to each other, the sound outlet hole has a second projection on the reference plane, for each of the plurality of first feature line segments, an endpoint of the two endpoints that is farther from the second projection is defined as a reference point; and
the plurality of reference points of the plurality of first feature line segments include a first reference point and a second reference point, a distance from the first reference point to the second projection is less than a distance from the second reference point to the second projection, the plurality of first feature line segments include a first sub-line segment and a second sub-line segment, the first sub-line segment passes through the first reference point, the second sub-line segment passes through the second reference point, the first sub-line segment has a first length, the second sub-line segment has a second length, and the first length is less than the second length.

2. The acoustic device of claim 1, wherein the sound output unit has a projection on the reference plane with a long axis direction, the first projection includes a first side edge parallel to the long axis direction and a second side edge disposed opposite to the first side edge, and the first reference point and the second reference point are both located on the second side edge.

3. The acoustic device of claim 2, wherein an angle between the second side edge and the first side edge is in a range of 0°-60°.

4. The acoustic device of claim 2, wherein, in the long axis direction, the first projection includes a first feature point that is closest to the second projection, a first feature length exists between the first reference point and the first feature point, a ratio of the first length of the first sub-line segment to the first feature length is a first length ratio; a second feature length exists between the second reference point and the first feature point, a ratio of the second length of the second sub-line segment to the second feature length is a second length ratio, and the first length ratio is greater than the second length ratio.

5. The acoustic device of claim 1, wherein for the plurality of first feature line segments, the longer the distance from the reference point of a specific first feature line segment to the second projection, the longer the length of the specific first feature line segment is compared to other first feature line segments in the plurality of first feature line segments.

6. The acoustic device of claim 2, wherein a length of the first feature line segment is in a range of 0.5 mm-1.6 mm.

7. The acoustic device of claim 6, wherein the one or more pressure relief holes include a first pressure relief hole, the first pressure relief hole is located on an upper side surface of the housing, and a length of a first feature line segment corresponding to the first pressure relief hole is in a range of 0.5 mm-1.6 mm.

8. The acoustic device of claim 6, wherein the one or more pressure relief holes include a second pressure relief hole, the second pressure relief hole is located on a lower side surface of the housing, and a length of a first feature line segment corresponding to the second pressure relief hole is in a range of 1 mm-1.6 mm.

9. The acoustic device of claim 1, wherein the diaphragm is connected to the housing via a bracket, each of the one or more pressure relief holes includes an outer port formed on the housing and an inner port defined by the bracket and the housing, an area of the inner port is less than an area of the outer port, and the inner port constitutes the effective vent port.

10. The acoustic device of claim 1, wherein the housing includes a connection end connected to the suspension structure and a free end opposite to the connection end, and the sound outlet hole is disposed closer to the free end than to the connection end.

11. The acoustic device of claim 10, wherein the sound output unit has a projection on the reference plane with a long axis direction, and in the long axis direction, the first reference point is closer to a center of a projection of the free end on the reference plane than the second reference point.

12. The acoustic device of claim 11, wherein a distance between the first reference point and the center of the projection of the free end on the reference plane in the long axis direction is a fifth feature length, a ratio of the first length to the fifth feature length is a fifth length ratio; a distance between the second reference point and the center of the projection of the free end on the reference plane in the long axis direction is a sixth feature length, a ratio of the second length to the sixth feature length is a sixth length ratio, and the fifth length ratio is less than the sixth length ratio.

13. The acoustic device of claim 1, wherein the sound output unit has a projection on the reference plane with a long axis direction, in the long axis direction, the first projection has two endpoints that are farthest apart, one of the plurality of first feature line segments that passes through a midpoint of the two endpoints divides the first projection into two parts, wherein a region enclosed by a part closer to the second projection has a first area, and another region enclosed by a part farther from the second projection has a second area, and the first area is less than the second area.

14. The acoustic device of claim 13, wherein a ratio of the first area to the second area is in a range of 0.5-0.99.

15. The acoustic device of claim 13, wherein the one or more pressure relief holes include a first pressure relief hole and a second pressure relief hole, the first pressure relief hole is located on an upper side surface of the housing, the second pressure relief hole is located on a lower side surface of the housing, a ratio of a first area of a first projection of the first pressure relief hole to a second area of the first projection of the first pressure relief hole is a first area ratio, a ratio of a first area of a first projection of the second pressure relief hole to a second area of the first projection of the second pressure relief hole is a second area ratio, and the first area ratio is less than the second area ratio.

16. The acoustic device of to claim 1, wherein the sound output unit has a projection on the reference plane with a long axis direction, in the long axis direction, the first projection has two endpoints that are farthest apart, and a distance between the two endpoints is in a range of 4 mm-6 mm.

17. An acoustic device, comprising:
a sound output unit, including a housing and a diaphragm accommodated in the housing, the diaphragm being configured to generate a sound through vibration;
a suspension structure, configured to position the sound output unit near an ear canal of a user without blocking the ear canal, wherein,
in a wearing state, an inner side surface of the housing facing an auricle of the user is provided with a sound outlet hole, the sound outlet hole is configured to guide a sound generated at a front side of the diaphragm out of the housing; side surfaces of the housing other than the inner side surface are provided with one or more pressure relief holes, the one or more pressure relief holes are configured to guide a sound generated at a rear side of the diaphragm out of the housing; wherein,
each of the one or more pressure relief holes includes an effective vent port, the effective vent port has a first projection on a reference plane, the reference plane is parallel or tangent to a side surface where the effective vent port is located, the first projection defines a plurality of second feature line segments that are perpendicular to the inner side surface, two endpoints of each of the plurality of second feature line segments are located on a contour of the first projection, and the plurality of second feature line segments are parallel to each other, the sound outlet hole has a second projection on the reference plane, for each of the plurality of second feature line segments, an endpoint of the two endpoints that is closer to a center of the second projection is defined as a reference point,
the plurality of reference points of the plurality of second feature line segments include a third reference point and a fourth reference point, a distance from the third reference point to the center of the second projection is less than a distance from the fourth reference point to the center of the second projection, the plurality of second feature line segments include a third sub-line segment and a fourth sub-line segment, the third sub-line segment passes through the third reference point, the fourth sub-line segment passes through the fourth reference point, the third sub-line segment has a third length, the fourth sub-line segment has a fourth length, and the third length is less than the fourth length.

18. The acoustic device of claim 17, wherein the sound output unit has a projection on the reference plane with a long axis direction, and in the long axis direction, the third reference point and the fourth reference point are located on a same side of the second projection.

19. The acoustic device of claim 17, wherein the sound output unit has a projection on the reference plane with a long axis direction, the first projection includes a first side edge parallel to the long axis direction and a second side edge disposed opposite to the first side edge, and the third reference point and the fourth reference point are both located on the first side edge.

20. (canceled)

21. The acoustic device of claim 19, wherein, in the long axis direction, the first projection includes a first feature point that is closest to the second projection, a third feature length exists between the third reference point and the first feature point, a ratio of the third length of the third sub-line segment to the third feature length is a third length ratio; a fourth feature length exists between the fourth reference point and the first feature point, a ratio of the fourth length of the fourth sub-line segment to the fourth feature length is a fourth length ratio, and the third length ratio is greater than the fourth length ratio.

22-33. (canceled)
